(19) United States
(12) Patent Application Publication
(10) Pub. No.: US 2015/0311857 A1
(43) Pub. Date: Oct. 29, 2015

(54) CONCENTRATING SOLAR PANEL WITH INTEGRATED TRACKER

(71) Applicant: Leo DIDOMENICO, (US)

(72) Inventor: Leo DIDOMENICO, Oakland, CA (US)

(21) Appl. No.: 14/647,080

(22) PCT Filed: Dec. 20, 2013
(86) PCT No.: PCT/US13/00282

§ 371 Date: May 22, 2015

Related U.S. Application Data
(60) Provisional application No. 61/748,038, filed on Dec. 31, 2012.
(60) Provisional application No. 61/835,014, filed on Jun. 14, 2013.
(60) Provisional application No. 61/893,748, filed on Oct. 21, 2013.

(51) Int. Cl. H02S 20/32; G02B 19/00; G02B 26/08; H02S 40/22

(52) U.S. Cl. CPC H02S 20/32; H02S 40/22; G02B 19/0042; G02B 26/08; G02B 26/0816; G02B 26/0875

(57) ABSTRACT

The present invention is an integrated sun tracking and concentrating solar panel that uses compact optical elements to track the sun and concentrate its sunlight to one or more energy conversion devices that are collocated on the solar panel. The invention eliminates the need for large mechanical solar trackers while also substantially increasing the efficiency of land use for arrays of solar panels.

### CROSS REFERENCE TO RELATED APPLICATIONS

This invention claims the benefit of U.S. patent applications: [1] U.S. 61/748,038 filed by the inventor, Leo D. DiDomenico, on 2012 Dec. 31 and entitled “Integrated Solar Tracker and Concentrator”, U.S. 61/743,038 is hereby incorporated in its entirety; [2] U.S. 61/835,014 filed by the inventor, Leo D. DiDomenico, on 2013 Jun. 14 and entitled “Integrated Solar Tracker and Concentrator”. U.S. 61/835,014 is hereby incorporated in its entirety; and [3] U.S. 61/893,748 filed by the inventor, Leo D. DiDomenico, on 2013 Oct. 21 and entitled “Integrated Solar Tracker and Concentrator”, U.S. 61/893,748 is hereby incorporated in its entirety.

### TECHNICAL FIELD

The present field of invention relates generally to solar panels and more specifically to self-contained solar panels that simultaneously integrate sun tracking, concentration and conversion of light into electricity within one module.

### BACKGROUND ART

Solar power systems that are based on arrays of solar receivers currently require that the user make a choice between either: [1] relatively low-cost, low-efficiency solar panels with about 10%-20% efficiency that can cover 80% or more of the footprint of a solar array or [2] higher-cost, high-efficiency solar panels that require concentration, with >40% efficient solar cells, and sun tracking covering as little as 20% of the supporting area. The use of the highest efficiency solar receivers, which require sun tracking, therefore reduces the use of the available sunlight. Consequently, a primary advantage of using advanced solar ceils with the highest efficiencies, is destroyed by the corresponding loss of valuable area that could be captnring sunlight and converting it to electricity. This is important when the supporting area of a solar array is limited, expensive, or otherwise somehow restricted. It is the object of embodiments of the present invention to overcome this problem.

The underlying problem is more easily seen with the aid of FIG. 1, which shows a number of representative geometries of prior art of solar power plants. Each configuration shown in FIG. 1 is demonstrated by the use of 16 solar receivers of equal area. The first array 1a shows sixteen solar receivers that have zero Degrees Of Freedom (DOF), are zenith facing and have a footprint bounded by square a₁a₂a₃a₄. The receivers in this ccmfiguration are typically solar photovoltaic panels based on Silicon PV (SiPV) or Thin Film PV (TFPV). Note that there is no panel-to-panel shadowing in this particular configuration.

The second array 1b shows sixteen solar receivers that have 0-DOF, are statically tilted up at an angle equal to the latitude angle of the installation and have a footprint bounded by the rectangle b₁b₂b₃b₄. The receivers in this configuration are typically solar photovoltaic panels based on SiPV or TFPV. Additionally, the spacing and tilting of each solar panel is chosen so that there is no panel-to-panel shadowing at any time of the year.

The third array 1c shows sixteen solar receivers that have 1-DOF that are capable of dynamically tracking the sun east to west, have a rotational axis that is parallel the ground 1g and have a footprint bounded by rectangle c₁c₂c₃c₄. The receivers in this configuration are typically solar thermal parabolic troughs . . . the receivers shown only represent the input area of the parabolic troughs. Again, the spacing and tilting of the solar receiver is usually chosen so that there is no receiver-to-receiver shadowing during the majority of the day. However, there is often substantial shadowing in the early morning and late afternoon.

The fourth array 1d shows sixteen solar receivers that have 1-DOF with a rotational axis that is tilted up at an angle equal to the latitude angle of the installation and have a footprint bounded by rectangle d₁d₂d₃d₄. Additionally, the receivers dynamically track the sun from east to west and also have a more direct average insolation in the north-south direction than array 1c. The receivers in configuration 1d are typically solar photovoltaic panels based on SiPV or TFPV. Again, the spacing and tilting of the solar panel is usually chosen so that there is no panel-to-panel shadowing during the majority of the day. However, there is often substantial shadowing in the early morning and late afternoon.

The fifth array 1e shows sixteen solar receivers that have 2-DOF, are capable of dynamically tracking the sun daily from east to west as well as seasonally from north to south and have a footprint bounded by rectangle e₁e₂e₃e₄. The receivers in this configuration are typically solar photovoltaic panels based on triple Junction PV (3JPV) or Stirling thermal engines. Again, the spacing and tilting of the solar panel is usually chosen so that there is no panel-to-panel shadowing during the majority of the day. However, there is often some shadowing in the early morning and late afternoon, but less so than in the previous 1-DOF configurations shown.

The sixth array 1f shows sixteen solar receivers that have 2-DOF, axe capable of dynamically tracking the sun daily from east to west as well as seasonally from north to south and have a footprint bounded by rectangle f₁f₂f₃f₄. The receivers in this configuration are typically heliostats and reflect the sunlight 1x into a solar tower 1w containing a closed-cycle thermo-electric generator. Again, the spacing and tilting of the solar panel is usually chosen so that there is no panel-to-panel shadowing during the majority of the day. However, there is often some shadowing in the early morning and late afternoon, but less so than in the previous 1-DOF configurations shown.

Each configuration shown has a fundamental grouping of solar receivers. In array 1a there is a receiver group 1h of sixteen individual solar receivers. In array 1b there is a receiver group 1i of four individual solar receivers. In array 1c there is a receiver group 1j of eight individual solar receivers. In array 1d there is a receiver group 1k of four individual solar receivers. In array 1e there is a receiver group 1m of four individual solar receivers. In array 1f there is a receiver group 1n of only one individual solar receiver.

Associated with these configurations of solar receivers are usually shadow lines that define the separation of each group of receivers within the footprint of the power plant. In array 1a there are no shadow lines. In array 1b a representative winter solstice shadow line is 1o. In array 1c a representative morning shadow line is 1p. In array 1d a representative winter solstice shadow line is 1q and morning shadow line is 1r. In array 1e a representative winter solstice shadow line is 1s and morning shadow line is 1t (which is cast by a neighboring group of four receivers not shown in the figure). In array 1f a representative winter solstice shadow line is 1u and morning shadow line is 1v.

If we define A(a₁a₂a₃a₄) as the area contained by points a₁a₂a₃a₄) and provide similar definitions for other areas, then FIG. 1 implies that A(a₁a₂a₃a₄)<A(b₁b₂b₃b₄)<A(c₁c₂c₃c₄)<A(d₁d₂d₃d₄)<A(e₁e₂e₃e₄)≦A(f₁f₂f₃f₄).

As more advanced and expensive solar receivers have been deployed there has been an engineering trend to maximize the radiation received by individual solar receivers by pointing these receiver evermore directly at the sun and by making the arrays ever more sparse. The result of using sun-directed pointing for solar receivers is that the fractional amount of available sunlight that is actually captured has been decreasing. Said another way, advanced solar receivers are actually becoming less, not more, efficient at using the available sunlight in a fixed area. Clearly a better solution is needed when the area of a solar array is limited or expensive.

To overcome this problem embodiments are provide for an integrated solar panel having a sun-tracker located within a transparent medium, such as transparent glass or a liquid, instead of tracking the sun from within the air directly. To motivate the value of the embodiments shown let's consider the performance of solar trackers in air and then in a transparent medium like glass or a liquid. Sun trackers embedded within air are similar to that shown in FIG. 2A, wherein, we see an east-west cross section of a tracking array 2a in its morning configuration. The array can be either 1-DOF or 2-DOF and is set on the ground 2b. Observe that the early morning sunlight 2c is 100% intercepted by the tracking solar panels. An example of a solar panel on a tracker that is 2d (a receiver), which is configured for the morning reception. Clearly in the morning, when the sun is close to the horizon plane, there is a very efficient utilization of the available sunlight . . . 100%. Morning shadows, such as 2e, clearly do not interfere with the operation of collecting sunlight. The same principles also hold during the evening when the sunlight is coming from the opposite direction (not shown). In contradistinction, FIG. 2B shows the same east-west cross section in the noon configuration 2f. Clearly only a small fraction the sunlight, a portion of which is shown as light 2g intercepting receiver 2h, is usable by the array of tracking receivers during the mid afternoon . . . i.e. when the sun is strongest and highest in the sky. An example of a typical solar receiver on a tracker is 2h. At noon the inter-tracker region 2i is clearly where there are significant losses of sunlight and energy.

Current solar tracking systems have the greatest efficiency at harvesting the available solar energy falling on a fixed area of land when the sun is least intense, in the early morning and late in the evenings. This is completely contrary to what is needed to maximize performance. Ideally, the efficiency in capturing solar energy across a fixed area should be 100% independent of the time of day.

FIG. 3 shows schenmtically an example of sky compression wherein a system 3a with the sun 3b having an emittance half-angle 3c of approximately 0.275 degrees, the sky 3d, an observer 3e floating and embedded within a transparent medium 3f. Within the transparent medium the observer sees the sky as a compressed cone 3g instead of the hemispherical sky 3d. Over the course of a day the path of the sun is optically compressed so that the direct morning light 3h, noon light 3i and evening light 3j are compressed into the cone 3g. In this disclosure the transparent medium is either a solid or a liquid phase.

FIGS. 4A. and 4B shows what happens when an array of solar receivers, such as shown in FIGS. 2A and 2B, are embedded within a transparent medium with the refractive index of glass . . . i.e. about 1.5. Specifically, a bundle of morning sunlight 4a is refracted into a stator 4b at said stator's first surface 4c. Individual receivers, such as 4d, receive essentially all the directly incident sober energy before said solar energy can reach the ground 4e.

Moreover, the spacing between a receiver 4d and its neighbor is now smaller than for the receiver 2d and its neighbor. This smaller spacing occurs without having panel-to-panel shadowing, which would cause nonuniform illumination of photovoltaic cells and a corresponding decrease in conversion efficiency from sunlight into electricity due to the resulting impedance mismatch formed by the shadowing. At noon a bundle of rays 4f passes through a transparent dielectric's first surface 4g, then through the transparent dielectric's bulk 4h and into a rotated solar panel 4i. Very little of the incident solar energy makes it to the ground 4j, Although not shown in. FIGS. 4A and 4B, the best performance occurs when the transparent dielectric's first surface 4c is covered in a layer of anti-reflection coating, but even without anti-reflection coating there is a significant advantage to this configuration in terms of the increase in sunlight collected averaged over the full range of sun tracking.

FIG. 5 quantifies the performance of the prior art, as exemplified in FIGS. 2A and 2B, and compares it to the performance of the system shown in FIGS. 4A and 4B. Specifically, the percentage of the utilized sunlight relative to the total available sunlight over the totality of the footprint of the power plant, is plotted in FIG. 5 as a function of incident angle relative to the local zenith direction. Curve 5a is representative of the present invention and curve 5b is the prior art. This plot ignores the particular type of solar cell in use and just considers the geometric factors involved. There a clear advantage to tracking the sun from within a transparent medium.

There is a subtle and important point to note: not ail solar receivers are based on solar cells that are sensitive to shadows, which cause impedance mismatches within the solar panel and loss of efficiency. For example, the heliostats in 1f can cast shadows on each other and not adversely impact the performance of the system (other than needing more heliostats for a given area) because the energy conversion system is remote from the individual heliostats and because there is no shadowing of solar cells. In such cases there is an even more significant advantage to sun tracking from within a solid or liquid transparent medium. Specifically, the advantage is that even higher levels of area coverage are possible with some shadowing allowed. This reduces complexity and is the case for the present invention. It is discussed in more detail in subsequent sections.

FIGS. 6A-D goes one step further and shows the cumulative electrical energy collected over the course of a year for a plot of land (or a roof) of fixed area of 10,000 square meters (about 2.5 acres) for different major classes of Prior Art (PA) solar technologies and compares it to representative embodiments of the present invention (PI). The average insolation is 9 kWh/m²/day Direct Normal Incidence (DNI) at a latitude of 35°. Each graph compares the same PI to other configurations and the full orbital mechanics and numerical techniques are utilised to see the cumulative energy collected as a function of time. The PI comprises 35% efficient solar panels built using 3JPV solar panels having 44% efficiency (i.e. about 9% of the panel's efficiency is lost internally to the panel), with an integrated 1-DOF sun-tracker that is mounted on the ground and zenith facing. This is similar to configuration 1c, except that the tracking elements of the array are embedded within a transparent medium having a refractive index of about 1.5 and this provides the means to eliminate sunlight leakage through each of the PI solar panels as well a dense packing of the PI solar panels to form the power plant. Each prior art curve of FIG. 6 is labeled with three pieces of information: the corresponding array configuration from FIG. 1, the solar panel efficiency, and the percent of the supporting area that receives sunlight due to the particular geometry of the array.

In particular, FIG. 6A shows prior art for a 2-DOF Concentrating photovoltaic (CPV) system. The general configuration of this prior art system is illustrated in 1e. The PA system of FIG. 6A also uses 3JPV solar cells and are always sun facing due to the 2-DOF tracking. The panel efficiencies, which are less than the 3JPV solar cell efficiency, are listed in the figure and are the best publicly available data that could be found at the time of the writing of this document. It is seen that there is an energy collection improvement of approximately 2.9 times . . . a 190% increase over the prior art. Rosenberg FIG. 6B compares the PI to SIPV systems configured as illustrated in FIG. 1 as 1a 1b, 1c, and 1d. All of the prior art systems considered use SiPV with a 22% panel efficiency. In this case the performance of the PI is larger than the best PA in FIG. 6B by a factor of 1.55. That is a 55% improvement of the PI for annual energy collected over the prior art.

FIG. 6C compares the PI to TFPV, configured as illustrated in FIG. 1 as 1a, 1b, 1c, and 1d. The PI now provides roughly a 190% increase in performance over the prior art.

Finally, FIG. 6D shows Concentrating Solar Power (CSP) systems, which use thermal energy in a heat engine to produce electricity. The CSP systems shown include dish concentrators using Stirling engines, solar thermal towers, and parabolic concentrator troughs. Again, we can see almost a 100% increase in performance of the PI over the PA.

These numbers are only representative and are provided to guide the reader's understanding that sun tracking, within a dielectric medium like glass or a transparent liquid, can provide substantial improvement in the annual energy collected.

### SUMMARY OF THE INVENTION

### Technical Problem

As more advanced and expensive solar receivers have been deployed using high-performance solar receivers there has been an engineering trend to maximize the radiation received by individual solar receivers by pointing these receivers evermore directly at the sun using conventional mechanical sun trackers. This has occurred by making the arrays ever more sparse on the supporting area. The result is that the fractional amount of the available sunlight that is actually captured by a fixed area supporting the solar array has been decreasing. Said another way, advanced solar receivers are actually becoming less, not more, efficient at using the available sunlight in a fixed are . . . e.g. a roof or restricted parcel of land. Clearly a better solution is needed when the area of a solar array is limited or expensive.

### Solution of the Problem

A solution is provided that is based on an integrated tracking and concentrating solar panel having a total of seven functional component types including: stators, rotors, deflectors, injectors, impedors, aggregators and receivors (spelled differently than the word “receivers”). The function of these devices is now provided in the order that light passes through them in the PI.

In particular, the first optical part of the solar panel that sunlight propagates through is a stater, which is an optical device typically in the form of a transparent slab forming the first surface of the solar panel. Its function is to refract light from a hemispherical region (such as the sky) filling about 2π steradians of solid angle and to reduce that hemispherical region to a cone having less than 2π steradians within the stator itself. This has the effect of reducing the angular tracking requirements of subsequent optical elements contained within the stator. The stator also protects the solar panel's internal optical elements from the environment.

The second type of optical devices within the solar panel are rotors, which are optical devices that rotate and redirect light propagating within the stator into a restricted angular range. The redirection of the light is by refraction or reflection or a combination thereof. The rotor also provides a real or virtual focus at the center of rotation of the rotor thereby providing a finite number of discrete focused regions of light independent of the position of the sun. The result is much the same for either real or virtual focal points, namely that the light is always sourced from well defined focal regions, with a predetermined angular extent of the sunlight over the course of a day and the seasons. This allows tracking to occur independent of the position of the sun.

The third type of optical device that sunlight propagates through in the PI are deflectors, which are optical components that focus the sunlight from a real or virtual focus to a tight focus at or near a light guiding structure. The tight focus typically has a concentration that is often much greater than the ultimate solar panel concentration. A deflector may comprise a number of sub-components associated with different directions of incident light from a rotor. A deflector also uses a combination of reflection, or refraction to achieve its function. The tight focus provided by the deflector is the setup for the creation of a kind of “light diode” that lets light pass into an expansion volume of an aggregator and remain trapped therein.

The fourth type of optical device that sunlight propagates through are a plurality of injectors. Injectors are the devices that actually provide light insertion and angular expansion of radiation into an aggregator by means of highly area-constrained apertures. In this way light can enter an aggregator and not easily escape. An injector adds its radiation to that already within the aggregator's expansion volume. An injector may also transform light by directing it to another focus within an aggregator, thereby providing another stage of concentration.

The fifth optical device that sunlight propagates through is at least one aggregator, which forms an expansion volume into which radiation is accumulated and concentrated. An aggregator is typically an asymmetric device, which is stepped in cross section, within which light propagates substantially in only one direction. It may be constructed so as to be spectrally selective and focus light within a narrow spectral band. The stepped cross sectional profile is sometimes described by three terms: [1] the going (a noun) is the horizontal length along a step, [2] the rise is the vertical distance from step-to-step and [3] the riser is the actual profile that connects a going at one level to a going at another level. Many ennbodiments shown have the riser of a step as both the injector's input and output surface. A simple optical slab, like flat glass plate, is said to have two goings: one on each side. Note that the input apertures associated with the injectors are located on or about the aggregator.

The sixth optical device is an impedor, which is at least one region surrounding an aggregator that is used to restrain (or “impede”) light from leaving the aggregator. As such an impedor is typically just an air or vacuum region situated around an aggregator and it has a lower refractive index than the aggregator so that total internal reflection (TIR) becomes possible within the aggregator.

The seventh optical device is a receivor, which typically collects sunlight and transforms it into another form of energy such as electricity. This device is of course critical to the system, and it comes in many different forms, some examples include; a 3JPV cell, a thermal energy converter, a photochemical reactor or even just a light pipe to a remote location are all possible receivors. Note that in this document the word receiver refers to an entire system, typically for the prior art, while the word receivor refers to the device optically connected to an aggregator.

These optical devices, in combination with a precision actuator and tracking control signals, allow rotation of the rotors within a thin stator and provides a means to redirect light, using deflectors, injectors and aggregators, to create a compact tracking solar panel that is able to fully utilize the available land area.

### Advantageous Effects of the Invention

Accordingly, the following advantages of the invention apply:

It is an advantage of this invention to provide at least a 50% increase in annual energy harvested compared to best in class SiPV solar array PA using the same supporting area for an array of solar receivers.

It is another advantage of this invention to provide at least a 100% increase in annual energy harvested compared to best in class CSP solar array PA using the same supporting area for an array of solar receivers.

It is another advantage of this invention to provide at least 150% increase in annual energy harvested compared to best in class CPV solar array PA using the same supporting area for an array of solar receivers.

It is another advantage of this invention to provide at least 200% increase in annual energy harvested compared to best in class CPV solar array PA using the same supporting area for an array of solar receivers.

It is another advantage of this invention to provide a thin, compact and robust solar panel that is low in cost.

It is another advantage of this invention to provide a thin and compact solar panel that has a low profile that is not adversely impacted by strong winds.

It is another advantage of this invention to provide access to solar resources when the supporting area for a solar array is limited in extent or expensive.

It is another advantage of this invention to minimize the ecological footprint of a solar array on the environment by maximizing the amount of energy that is harvested for a given area.

It is another advantage of this invention to maximize financial profits or energy savings derived from solar energy harvesting on a fixed area by obtaining more energy per unit of array area.

Further advantages of the invention will be brought out in the following portions of the specification, wherein the detailed description is for the purpose of fully disclosing the invention without placing limits thereon.

### BRIEF DESCRIPTION OF DRAWINGS

The foregoing discussion and other objects, features, aspects, and advantage of the PI will become apparent from the following detailed description of embodiments and drawings of physical principles given by way of illustration. Unless otherwise stated the figures are drawn for improved clarity of the underlying physical principles and are not to scale.

FIG. 1 shows prior art solar array configurations and associated area requirements.

FIG. 2A shows a prior art solar tracking array in the early morning just after the sun rises.

FIG. 2B shows a prior art solar tracking array at noon and functioning within air.

FIG. 3 shows compression of a hemispherical sky.

FIG. 4A shows a solar tracking array in a transparent medium in the early morning.

FIG. 4B shows a solar tracking array in a transparent medium at noon.

FIG. 5 shows sunlight utilization as a function of incident angle to the stator.

FIG. 6A compares the present invention & other Concentrating PV (CPV) arrays.

FIG. 6B compares the present invention & other Silicon photovoltaic (SiPV) arrays.

FIG. 6C compares the present invention & other Thin Film photovoltaic (TFPV) arrays.

FIG. 6D compares the present invention & other concentrating Solar Power (CSP) arrays.

FIG. 7 shows in cross section, a portion of a PI concentrating solar panel at early morning.

FIG. 8 shows in cross section a portion of a PI concentrating solar panel at late afternoon.

FIG. 9 shows in cross section a solar panel's actuation and thermal management.

FIG. 10A shows a three dimensional perspective of the linkage-based rotors.

FIG. 10B shows a three dimensional perspective of the friction-based rotors,

FIG. 11 shows in perspective a cylindrical rotor with rays not normal to the rotation axis.

FIG. 12 shows a spherical rotor tracking the sun with a time-averaged geodesic.

FIG. 13 shows an array of spherical rotors actuated by a friction plate.

FIG. 14 shows in cross section a single rotor with a real focus from two mirror surfaces.

FIG. 15 shows light from a rotor focused by a deflector, injector and stepped aggregator.

FIG. 16 shows in cross section a refractive rotor with a virtual focus.

FIG. 17 shows a cross section refractive deflectors and an flat unstepped aggregator.

FIG. 18 shows in cross section a lens based deflector and step shaped aggregator.

FIGS. 19A-D shows different stepped aggregators with injectors on the second surface.

FIG. 20 shows an. aggregator with refractive injectors on the aggregators first surface.

FIG. 21 shows a three dimensional perspective of rectangular aggregator.

FIG. 22 shows a three dimensional perspective of an aggregator formed as a parallelogram.

FIG. 23A shows an single ray propagating into a wedge-shaped injector.

FIG. 23B shows many rays propagating into a wedge-shaped injector.

FIG. 24A-B shows a wedge injector with different mirrors lengths.

FIG. 25 shows a three dimensional perspective of wedge-shaped injector.

FIG. 26 shows a three dimensional perspective of a protected wedge-shaped injector.

FIG. 27 an injector based on surface patterning on an aggregator.

FIG. 28 shows a three dimensional deflector lens array, injectors and aggregator.

FIGS. 29A-C shows examples of how controlling the injection direction can focus sunlight.

FIGS. 30A-B show an aggregator using angular-band, limited uniform diffusers for injectors.

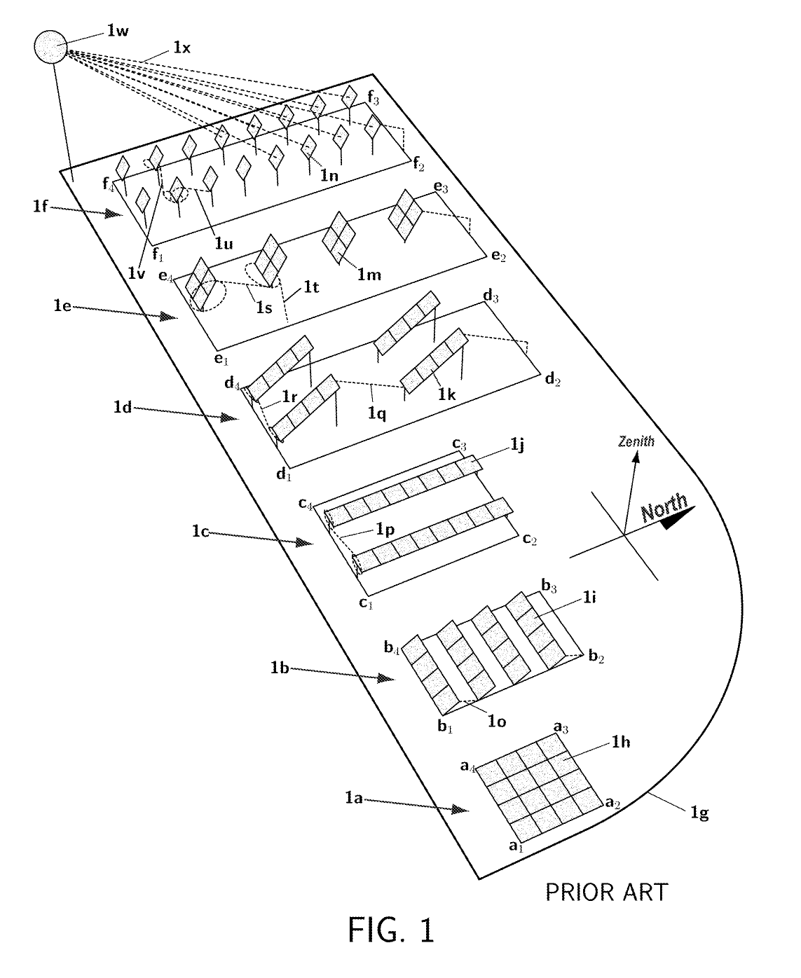

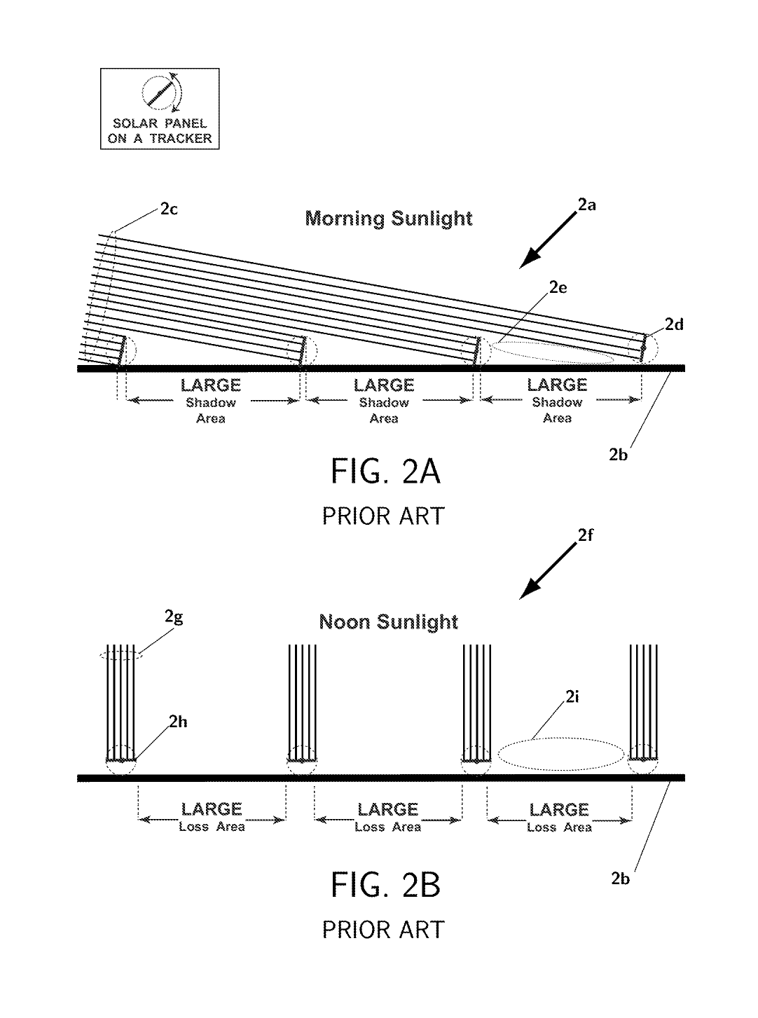

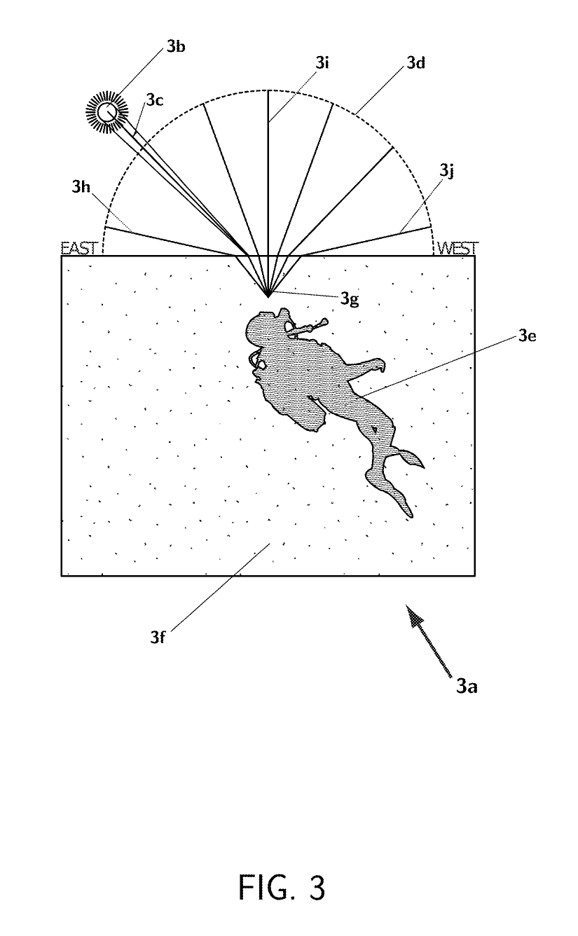

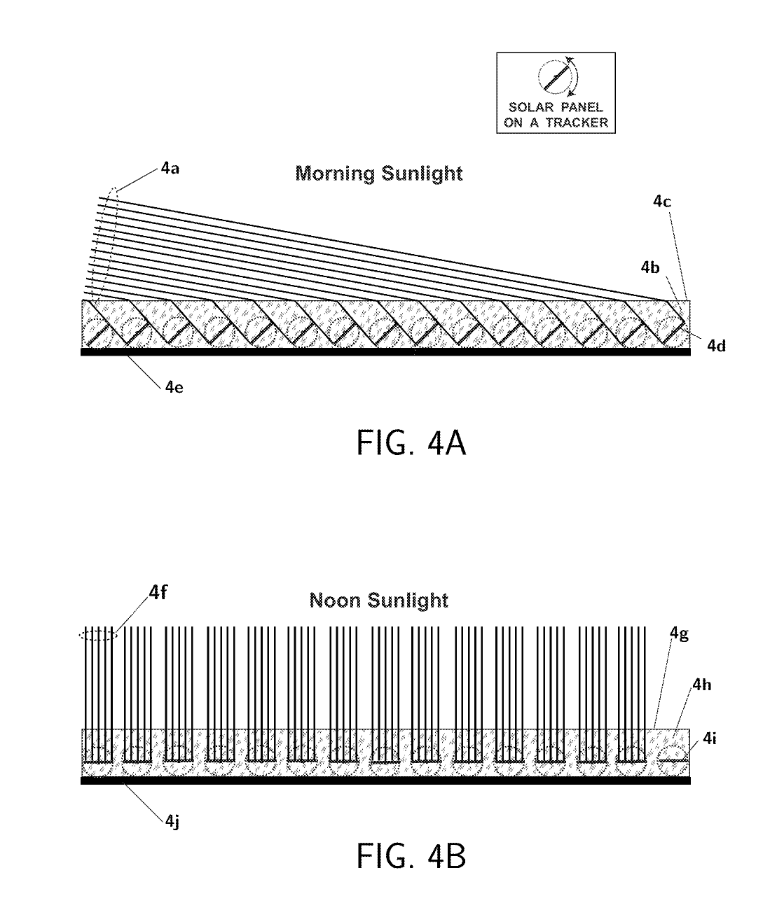

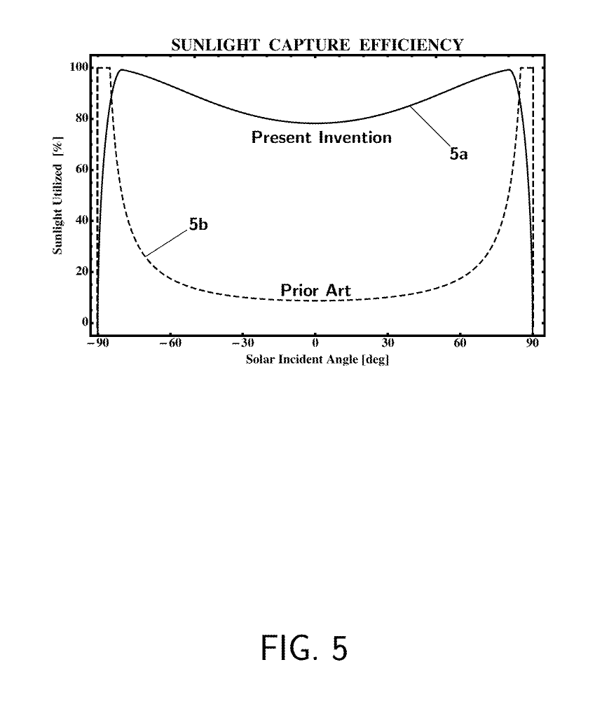

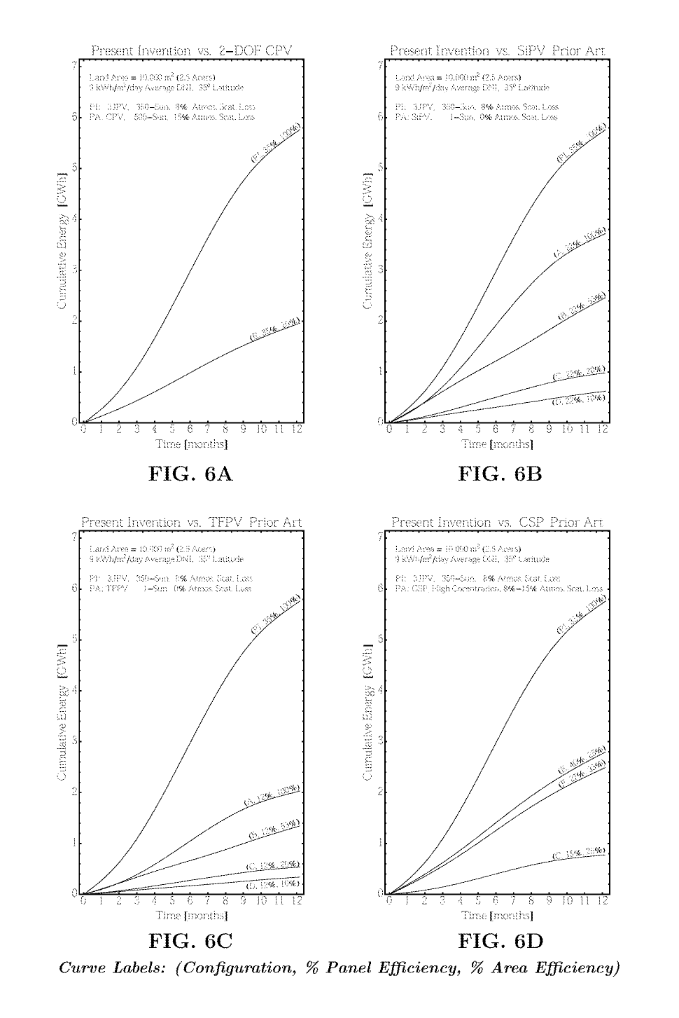

### DESCRIPTION OF THE EMBODIMENTS

This section provides the operational principles underlying integrated solar tracking and energy conversion systems. These systems are formed by the primary components: stators, rotors, deflectors, injectors, impedors. aggregators and receivors; each component of which has multiple ways of being embodied in practice.

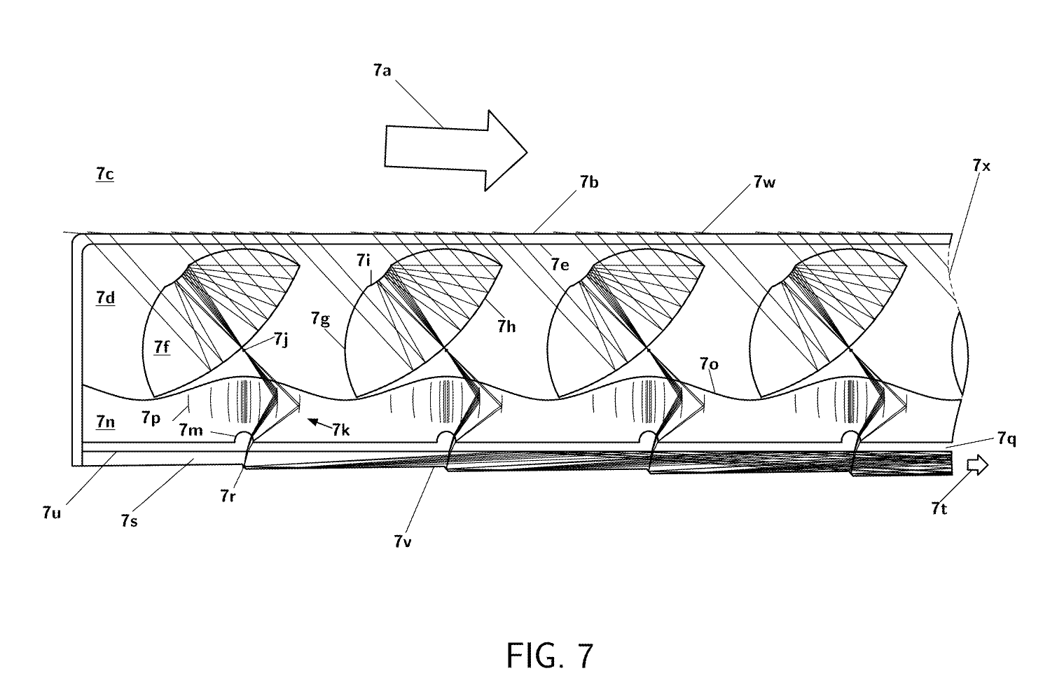

Consider FIG. 7, which shows a cross section of a portion of one embodiment of an active tracking solar panel. Incident sunlight 7a illuminates the first stator surface, called the tracker optical input surface 7b. An example of an individual light ray entering surface 7b is ray 7w. The outer surface of the stator is formed by a solid sheet of transparent material, typically formed by a glass or a transparent plastic, and it refracts sunlight from the air 7c into the bulk stator material 7d through said transparent sheet having a second surface 7e. The refractive index of said solid sheet of transparent material, which is formed between surfaces 7b and 7e, need not have the same refractive index as the remaining stator material 7d. The stator material 7d is formed by an index matching fluid, which may be made from a number of different chemicals, including but not limited to: Cargrille Laboratories Acrylic refractive index matching fluid. Cargrille Laboratories BK-glass refractive index matching fluids, an aqueous solution of mono-propylene glycol optimized for low temperature viscosity resistance or even glycerin. In most all cases it is critical that the containment vessel that holds the fluidic medium has no oxygen therein and is otherwise hermetically sealed; moreover the optical properties of said containment vessel should preclude the transmission of ultraviolet light for many of the potential candidate matching fluids. Coatings on the tracker optical input surface 7b may be used to achieve this ultraviolet light rejection. In this way long-term chemical stability of the index, matching fluids may be obtained. Also, the optical elements must be optimized for the specific fluids used.

In one embodiment the refractive index of the stator 7d is matched to the refractive index of each rotor, for example see the medium 7f. This allows rays of light to pass into rotors undeflected by the rotor's first surface. An example of a rotor's first surface is 7g. The light then reflects off of a primary mirror, an example of which is shown, as 7h. Next, the sunlight reflects off of a secondary mirror, an example of which is curved mirror 7i. The light then is focused to a point that may be either inside of a rotor or outside of a rotor. In the case of the example shown in FIG. 7 the focus point is 7j and is outside of the rotor medium 7f. Note that the means for mechanical rotation of the rotor is not shown in this figure, but is shown in subsequent figures. Moreover, the focal point 7j of a rotor is also at the center of rotation of said rotor 7j. In this way, as the rotor rotates to follow the sun over the course of a day, the location of the focal point 7j remains fixed. This will be shown in more detail in subsequent figures. Additionally, while the stator medium 7d is a fluid, the rotor medium 7f is a solid. In this way the primary and secondary mirrors, e.g. 7h and 7i respectively, are always aligned, optically linked and may be rotated together by an external agent.

The use of an index matching fluid solves several problems. First, it avoids to problem of having to manufacture a sold stator by (often expensive) precision machining or other techniques. Such a manufacturing operation is very difficult to achieve with both good accuracy and precision at very small scales associated with a thin solar panel. Moreover, the manufacturing is often made even more challenging as the precision machining would have to also cover large solar panel areas. The index matching fluid flows into all the features of the stator, rotors and deflectors allowing essentially a perfect fabrication to be achieved without the need for elaborate fabrication techniques. Second, the index matching fluid allows the rotors to rotate over only a restricted range of angles because the sky has been compressed as already described. This helps to improve the overall efficiency of the solar panel. Third, some of the potential candidate index matching fluids are also used in industry as antifreeze and heat transfer applications and can also provide a means for heat transfer in a solar panel. This opens the possibility of using the fluids for thermal management of the solar panel, which is an important consideration in optimising the efficiency of solar cells that become more efficient at lower temperatures, but are often forced to run hot due to intense concentrated sunlight. Fourth, in certain circumstances it is quite advantageous to have curved optical surfaces that do not refract between different medium . . . e.g. see surface 7g. This can provide a means of simplifying the optical design.

In FIG. 7 once the light has passed through the focal point 7j it is intercepted by at least one of the deflectors sub-mirrors. As an example we can see that the mirrors 7k are associated with the rotor center and focal point 7j. An example deflector of the solar panel is the grouping of deflector mirrors 7k and the refractive surface 7m, which together form one deflector. The deflector mirrors 7k are embedded within a solid transparent material 7n ideally having the same refractive index as the stator's index matching fluid 7d. This is why the rays coming from focal point 7j are not deflected at the optical surface 7o. Individual mirrors of a deflector, such as mirror 7p may be formed by means of a metallic layer, such as silver, by means of a patterned air gap so as to allow total internal reflection, or by means of periodic structures like photonics crystals and multilayer dielectric mirrors.

The light then passes into an air gap 7q, which forms an impedor, which is the air surrounding a portion of the aggregator. In the particular case shown in FIG. 7 the deflector's refractive surface 7m also forms part of the tracker optical output surface. The function of the impedor is to allow light to pass to the subsequent injector 7r and to then remain within an aggregator 7s without leaking light back into the surrounding environment. Note that an example of a riser of the aggregator is injector 7r and an example of a going of the aggregator is step segment 7v, which is also called the second surface of the aggregator In this embodiment. The aggregator shown has one injector for each rotor and it injects the sunlight into the aggregator. Different configurations may have more or less injectors for each rotor. An example of one of the solar panel injectors is surface 7r, which reflects by means of TIR, or by means of a metallic reflective surface, or a reflective surface based on periodic micro structuring of a material to form reflection by interference of waves or by means of a stochastic surface such an angular band limited uniform diffuser.

The light from each injector adds incoherently along the aggregator and propagates asymmetrically in the direction 7t by means of reflections off the first surface of the aggregator 7u and the second surface 7v of the aggregator. The sunlight eventually reaches a receivor (not shown in FIG. 7) such as a 3JPV solar cell and is converted into electricity. The aggregator shown in FIG. 7 is based on a “staircase” shape and expands in cross sectional area as one progresses along towards the receiver . . . in the direction 7t. The staircase shape protects injectors from leaking light out into the environment that is already propagating within the aggregator. The added volume of this shape is a requirement of étendue conservation as the aggregator is adding in more light at each injector it needs more room in phase space to ensure that the light remains trapped within. The aggregator can support upwards of about 350 suns of concentration if it has a refractive index of about 1.8 and this corresponds to several hundred cylindrical rotors in cross section. Only four complete rotors are shown due to space limitations. Note that the portion of the solar panel shown in FIG. 7 continues on in the direction 7t and this is represented by the dashed curve 7x.

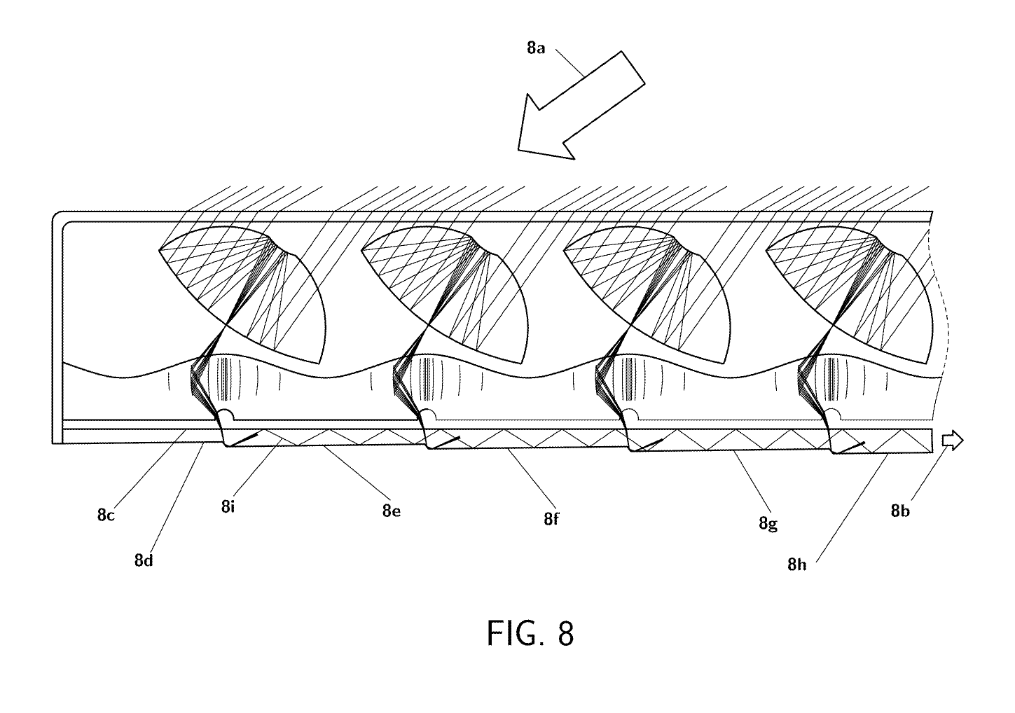

FIG. 8 shows the configuration of the solar panel in mid afternoon. Notice that each of the rotors has now rotated to align itself with the new direction of propagation of the sunlight 8a. The solar panel functions the same as in FIG. 7, but with different deflector sub-mirrors being used to redirect the sunlight in each deflector. The result shown in FIG. 8 is much the same as in the previous figure and results in sunlight being trapped and directed in the direction 8b within the aggregator even though the sun is at a completely different position in the sky. The light eventually reaches the receiver (not shown in FIG. 8) and is converted into electricity.

FIG. 8 does not show as many of the rays propagating as in the previous figure so that it is easier to see the aggregator. The first surface of the aggregator is formed by a single surface 8c, a going, that is flat and parallel to the average direction of light propagation within the aggregator. The second surface of the aggregator is formed by a plurality of sub-surfaces that are typically flat and often (but not always) parallel to the first surface. In FIG. 8 the second surface of the aggregator is formed in part by surfaces 8d, 8e, 8f, 8g and 8h. These are different goings of the steps. These surfaces contain the ray 8i as it propagates down the aggregator structure. The reflection is ideally based on TIR. To achieve the maximum allowable concentration provided by nature the rays at the receiver must completely fill the allowable phase space (formed in both photon momentum and position). This requires that the rays propagate in all physically allowed exit directions at the output of the aggregator. This can be achieved by slightly adjusting the shape (and/or angle) of the each of the aggregator's second surface sections.

Carefully look at the aggregator in FIG. 8 and you will notice that the second surface elements are not perfectly parallel to the aggregator's first surface. This perturbation from parallel may be done to change the angular propagation mode within the aggregator to help achieve maximum concentration at the receivor. Each of the aggregator's second surfaces may be at a different angle. The same idea is also true of the injectors and each injector may be at a different angle. It is worth noting that each mirror and refracting element of the deflector array as well as each injector and each second surface of the aggregator needs to be optimized separately so that the entire solar panel works to maximally concentrate the sunlight at the receivor.

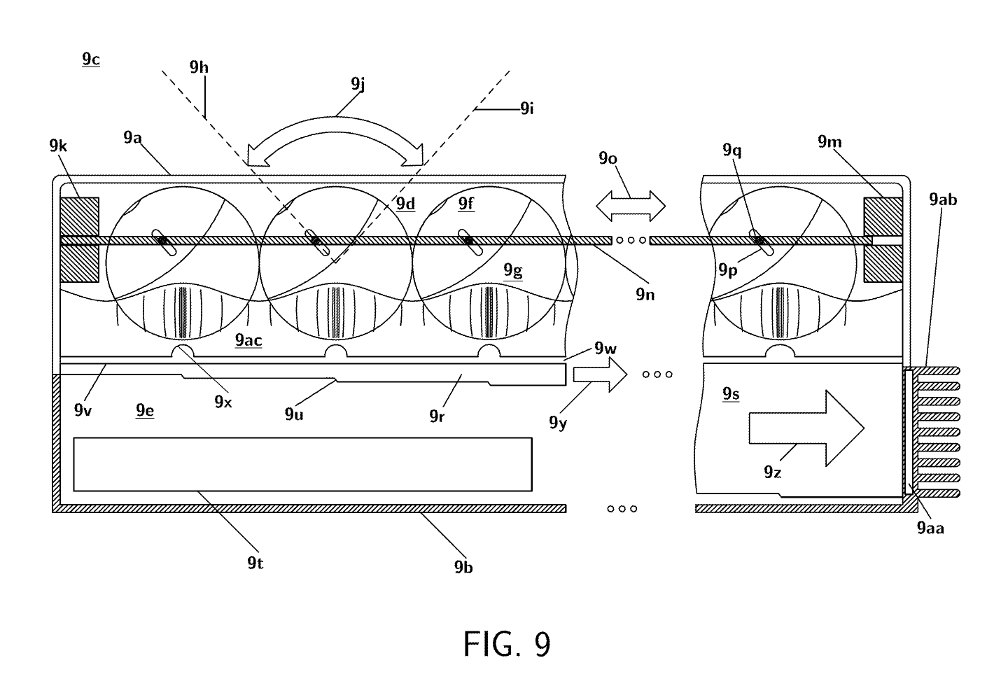

FIG. 9 shows a more complete version, in cross section, of the solar panel from FIGS. 7-8 wherein both actuation and thermal management components are also shown. The solar panel has an outer layer of transparent material 9a, which is considered to be the first member of a solar panel enclosure. The first member of the enclosure also forms the tracker's optical input surface. The solar panel enclosure also has a second member 9b formed by a typically non-transparent material, e.g. aluminum. The first member and the second member of the solar panel enclosure provide a hermetic seal that keep the surrounding air 9c separate from the index matching fluid 9d and a clean dry atmosphere 9e within the lower enclosure of the solar panel. The clean and dry atmosphere 9e may be formed by dehumidified nitrogen and it functions to keep the aggregator optics clear of dirt and free from condensation.

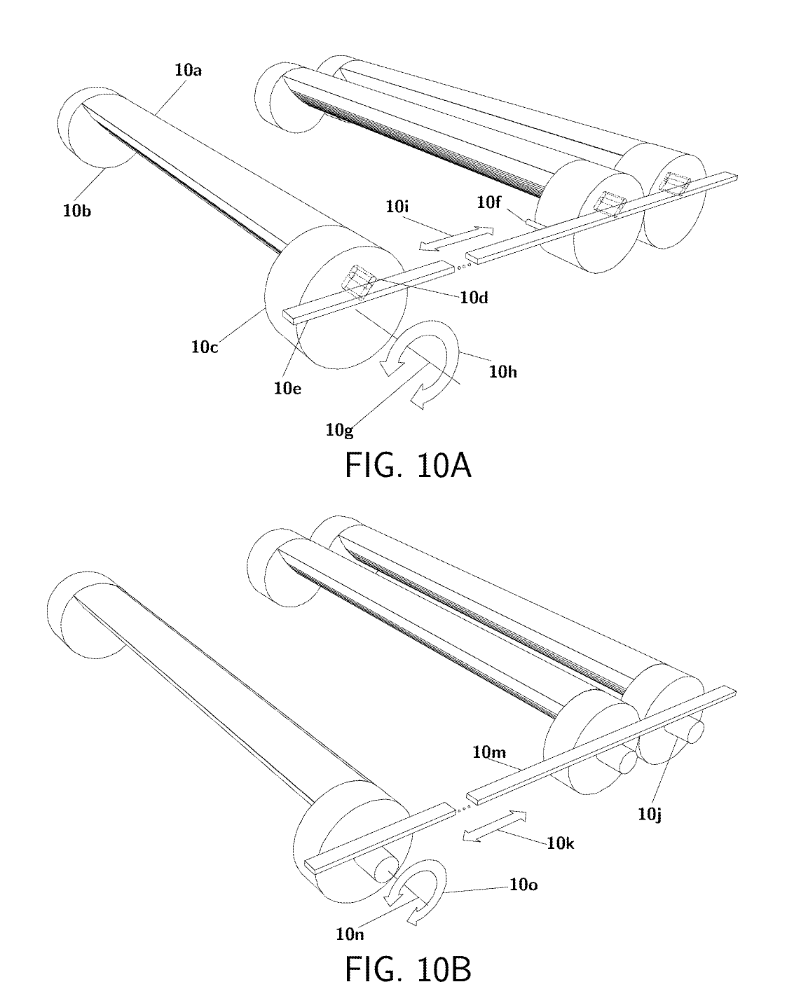

The rotors are mechanically rotated by means of mechanical connections at the cylindrical end caps . . . see FIG. 10A for a three dimensional perspective. In particular, the optics are formed from a transparent material 9f. The end caps of each rotor are formed from a material 9g, which may be different from the optically transparent material 9f. Each rotor rotates from a morning “first light” angle, with optics axis parallel with line 9h, to a evening “last light” angle with optics angle parallel with line 9i, The angle 9j subtends lines 9h and 9i and corresponds to the compressed cone of the sky.

There are a number of potential actuation mechanisms that can be employed to rotate each rotor through an angle 9j each day. In FIG. 9 a linear actuator system comprising linear actuators 9k and 9m. These actuators are only shown in the abstract as there are many commercial off-the-shelf implementations. The system also comprising a linear shaft 9n that converts the linear motion 9o to angular motion 9j about the rotation axis by means of a slot in each of the rotors into which a drive protrusion engages. An example of such a slot is 9p and an example of the drive protrusion is 9q. As the shaft 9n moves back and forth in the directions 9o the drive protrusion 9p moves along its associated slot to rotate the corresponding rotor about its rotation axis. Recall that the rotation axis is the center-line of a cylinder and the line onto which sunlight is substantially focused.

There are a number of suitable implementations for the linear actuators 9k and 9m that can provide micron scale (or smaller) resolution in the positioning of the linear shaft 9n. This micron scale is necessary to ensure that the pointing error in the tracking of the sun is much less than the angular radius of the sun, which is about 0.275 degrees. Stepping motors with suitable encoders as well as piezoelectric actuators are capable of extremely high precision movements to track the sun at almost no power draw. In contradistinction, another means of actuation is provided by exploiting quasi-electrostatic forces as described by this author in U.S. Pat. No. 7,924,495 and titled as “Active-Matrix sun Tracker”.

The first member of the solar panel enclosure 9a, which wraps around the sides of the solar panel, protects the aggregator's optical input surface 9v as well as the air gap impedor 9w. The protection is provided by means of a hermetic seal to keep in the desired dry and inert gas, such as a zero humidity nitrogen gas. Alternately the impedor may be formed by means of a vacuum layer. This keeps the tracker optical output surface 9x and the aggregator optical input surface 9v clean and free from condensation. The deflector array is located within the solid transparent material 9ac and this forms a hermetic closure with the first member of the solar panel enclosure. The deflector material 9ac thus provides the means to keep the index matching fluid 9d within the first member of the solar panel enclosure.

The second member of the solar panel enclosure 9b protects the aggregator 9r and injectors (such as 9u), which are formed of transparent material 9s. The injector is formed on the riser of the stepped aggregator profile. The thin end of the aggregator also provides sufficient room for supporting solar panel electronics 9t, the location of which is shown schematically as box 9t. The electronics comprising optionally none or any of the following: a maximum power point tracker, to ensure optimum loading of the solar cells; tracking electronics, to control the tacking of the sun by means of signals sent to an actuator to rotate the rotors; standby power storage to ensure startup power to the solar panel even after prolonged dark periods; communication electronics for data telemetry, to allow each solar panel to be connected to the internet to communicate performance data, fault monitoring and remote control electronics and built-in base-load energy storage to allow the solar panel to provide energy even in times of no incident light.

FIG. 9 is broken into two parts as the scale of the solar panel is too large to fit on a single drawing page. The left side of the image shows the thin side of the aggregator. The right side of the image shows the thicker side of the aggregator. The light travels from left to right as indicated by the arrows 9y and 9z. This results in the sunlight striking a receiver, e.g. a 3JPV cell or solar cell array, 9aa located in contact with a heat sink 9ab, The heat sink may be formed as part of the second member of the solar panel enclosure or as a separately attached structure. In either case the hear sink 9ab can be extended to be in thermal contact with both the solar cells 9aa and the index matching fluid 9d. This provides the means to better manage thermal loading of the solar cells 9aa by drawing waste heat away from the 3JPV solar cell receiver 9aa into the stator medium 9d by radiative, conductive and convective dissipation into the surrounding air environment 9c via the large surface area of the solar panel optical input surface 9a, which is also the first member of the solar panel enclosure . . . also called the tracker optical input surface. The effectiveness of this technique depends on thermal conductivity of the index matching fluid 9d, which is provides the dual functionality of a medium for optical transmission of sunlight and for heat dissipation. Other solar cell types are also possible.

FIGS. 10A-B provides a three dimensional perspective of the rotors and linkages to the actuation motors, with all other details stripped away. This corresponds to FIG. 9. In particular, FIG. 10A shows an optical rotor 10a with end caps 10b and 10c. The end cap 10c has a slot 10d into which a protrusion from the actuation shaft 10e may slide to rotate the rotor. An example of such a protrusion is 10f.

Note, to avoid a cluttering in the figure the side walls of the solar panel have been omitted. These side walls may optionally have a complimentary receptacle within which the end caps fit to ensure that the rotors only have one degree of freedom, e.g. the rotation 10h about a rotation axis 10g. The rotation axis 10g also happens to coincide with the focal line when under the optical portion of the rotor 10a. When the side walls lack any receptacles for the end caps then the system of rotors itself provides the necessary constraint by means of the tight packing within the stator block. In this way a linear motion control signal 10i of the shaft transfers to angular motion 10h of rotor optics 10a.

In FIG. 10B the slot linkage is replaced with an end cap having a friction surface 10j. The figure shows the cylindrical friction surface having a smaller radius then the end cap, though this is not a requirement. In this way the linear motion 10k is transferred by friction from the linear shaft 10m to rotate each of the rotors about its rotation axis, such as rotation axis 10n to provide angular rotation 10o. It should also be obvious that instead of friction that gearing, similar to a rack and pinion can be used. These figures only show two variations of the actuation method and it is to be understood that in no way is this to be considered the only ways of actuation, but rather are to be taken as representative means to rotate the rotors. Additionally, linear motion 10k is understood to be controlled by a motor deriving its position from a signal sent from a controller, which is not shown in FIG. 10.

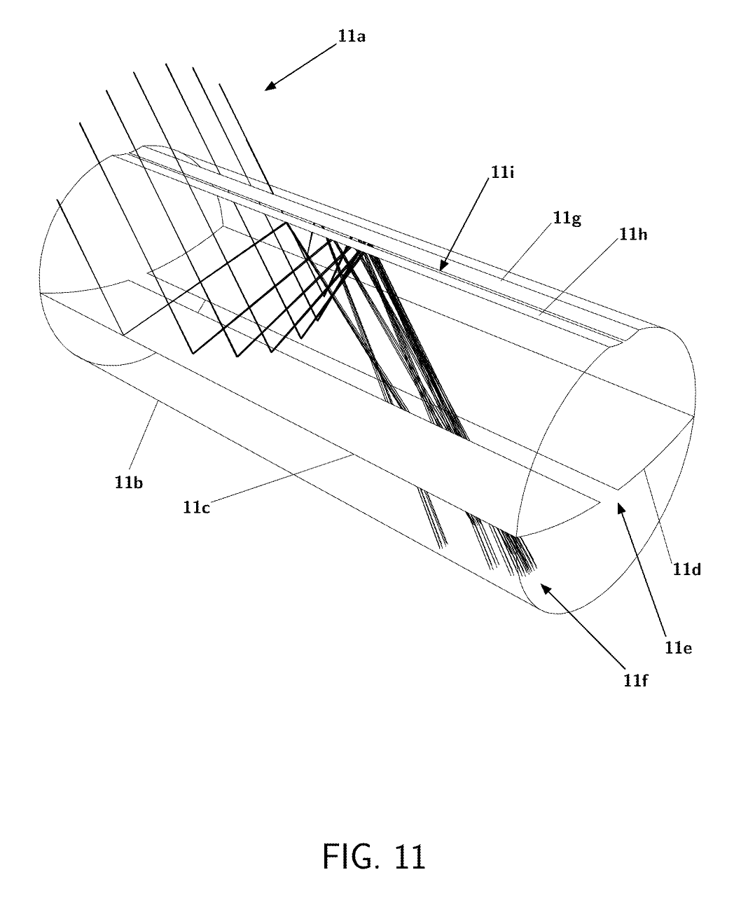

FIG. 11 shows how cylindrical rotors process rays that are incident onto a cylindrical rotor from an angle that is not normal to the rotational axis of the rotor. This is especially important in the case of solar panels that are laid flat on the ground above the Earth's equator so that the rotor's rotational axis is parallel to the ground and running in the north-south direction. In this case the sun is not directly overhead. As a result the rays from the sun are as shown in ray group 11a. Note that the rays are not refracted by passing through the cylindrical surface of the rotor 11b because the rotor is immersed within an index matching fluid—not shown. This fluid nullifies the refractive effect of a rotor made of transparent glass or plastic so long as the index matching fluid has the same refractive index as the rotor material.

FIG. 11 also shows that the incident rays 11a propagate along the rotor. The end of the rotor typically has a mirror or is mounted juxtaposed to a mirror to ensure the no light is lost out of the end—this is not shown in FIG. 11. The primary mirror shown Is composed of two half parts 11c and 11d, which are split along the center to allow the focused sunlight to propagate to a deflector array via a gap 11e. The output rays are indicated by ray group 11f. The secondary mirror may optionally be composed of two parts 11g and 11h. The secondary mirror may also have a gap 11i that divides it. The purpose of this secondary mirror gap is to allow direct sunlight to pass unobstructed and thereby partially reduce the losses from the secondary mirror. A gap such as 11i save up to several percentage points in lost solar energy. The three dimensional character of FIG. 11 should be understood to represent both specific attributes of a cylindrical rotor and more generally to show how sunlight can pass into a cylindrical rotor without being normal to the axis of rotation of the rotor. Other rotor designs will have similar configurations of rays that are not normal to the rotation axis.

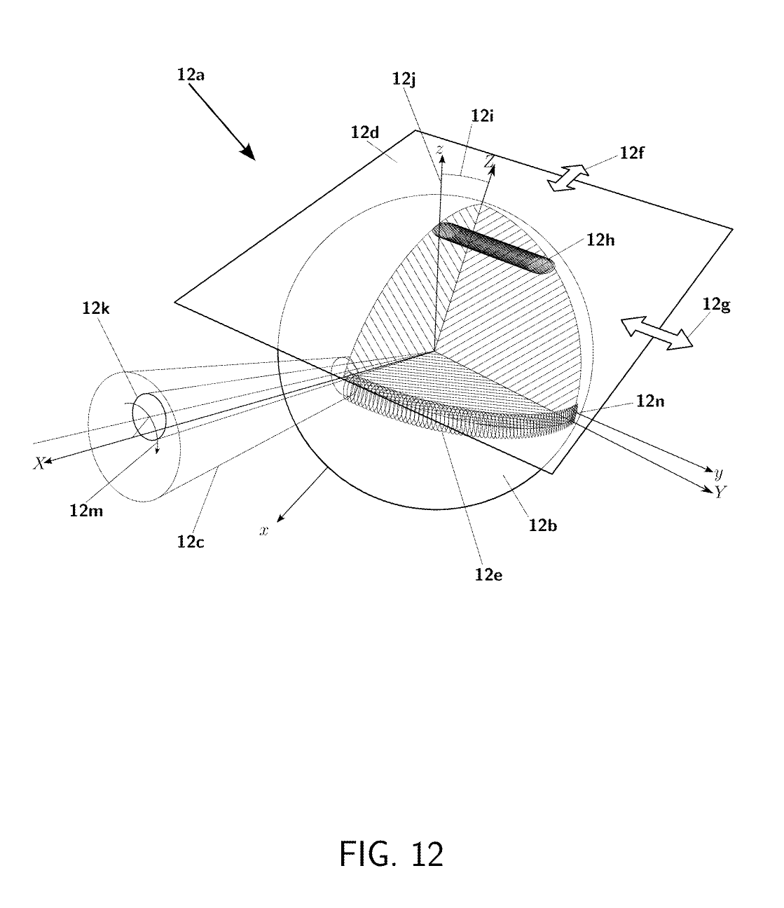

FIG. 12 shows an example of a spherical rotor. It has a circular cross section just as the cylinder did. FIG. 12 shows a system 12a comprising a spherical rotor 12b having a sunlight acceptance cone 12c, a friction plane 12d and a sun tracking path 12e, which is based on a time-averaged geodesic. The friction plane 12d is implemented as a rigid or semi-rigid sheet of transparent glass or plastic having a high static coefficient of friction with the spherical rotor 12b. The xyz-coordinate system is stationary; The XYZ-coordinate system is attached to the spherical rotor and can rotate. Both coordinate systems have the center of the rotor as the origin. The spherical rotor 12b has its center fixed in space so that it can not be translated. Note that the constraint that fixes the position, of the spherical rotor 12b is not depicted in FIG. 12 to keep the art uncluttered.

An actuator and force control signal 12f provides x-directed forces to move the friction plane in the x-direction. Another actuator and control signal 12g provides y-directed forces to move the friction plane in the y-direction. These signals and forces are coordinated to provide a flattened helical trajectory 12h of a fixed point on the frictional plane 12b. The harmonic form of this helix is shown in FIG. 12 and provides motion of a reference point on the friction plane as

r_{ref}= [symbol] Aₓ(1−bt−sin [ωₓt+φₓ]),A_{y} sin |ω_{y}t+φ_{y}|, R [symbol] . (1)

where Aₓ and A_{y} are the generalised control amplitudes provided by the x-directed and y-directed actuators, ωₓ and ω_{y} are the radian frequencies, φₓ and φ_{y} offset phases. R is the radius of the spherical rotor and b is a slightly different constant value for each day of the year and it controls the time-average value of the angle 12i that the average geodesic makes with, the zenith direction 12j. The result of this is that the sunlight acceptance cone 12c constantly moves relative to the image of the solar disk 12k, Relative to the sunlight acceptance cone 12c the solar disk appears to move in the direction indicated by the arrow 12m. This system provides a means to easily direct the sunlight acceptance cone 12c from horizon to horizon over the course of a single day and over the fall range of the sun's position during the course of a year. The starting position of the X-axis in the morning is shown as position 12n. The control signals that provide the helix 12h on the friction plane 12d may also take on other functional forms other than sine functions. For example the control helix may be driven by square waves instead of sines so long as the average trajectory is a geodesic.

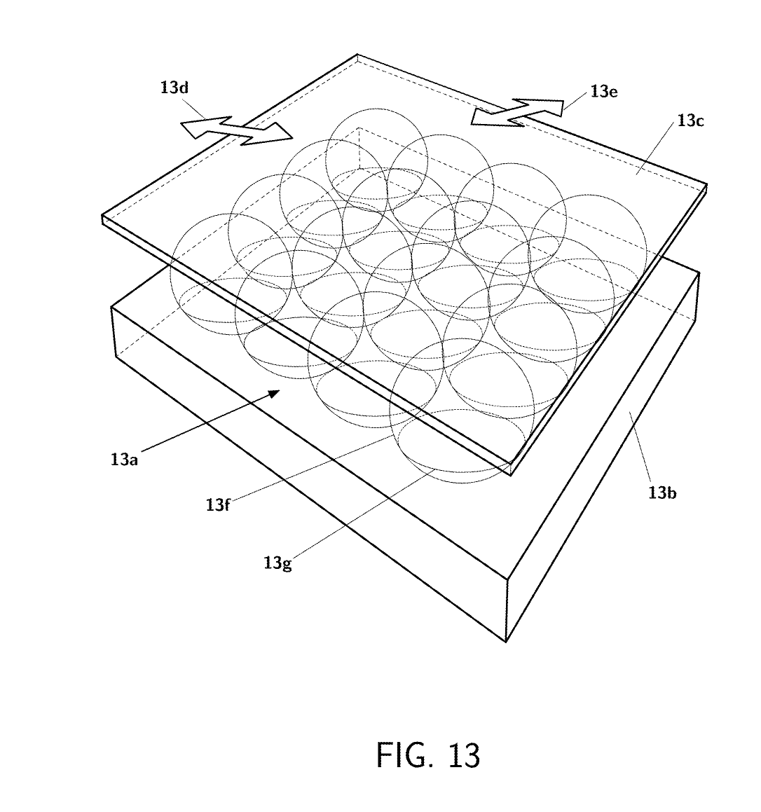

FIG. 13 shows a portion of an array of rotors 13a, a portion of the stator 13b and a portion of a friction plate 13c. Said portion being a part of a concentrating solar panel. The particular embodiment shown here is for a solar panel in the form of a parallelogram so that the array of rotors 13a may be maximally packed. This provides an area use efficiency of about 90%. The two required control signals, 13d and 13e are not necessarily at right angles to each other, as depicted in this embodiment. Consequently, the control signals would require a trigonometric modification from that already discussed to account for the projection of force. The individual rotors, such as 13f, are shown constrained in spherical insets 13g to a portion of the stator. These insets insure that the center of each rotor remains fixed with respect to the solar panel. The medium surrounding the rotors may be an index matching fluid so that the hard surfaces of the rotors have a minimal impact on the sunlight that passes though the transparent friction plate 13c. An advantage of tins configuration is that the array of spherical rotors are actuated at the same time by two motors, instead of needing a motor for each individual rotor of the array.

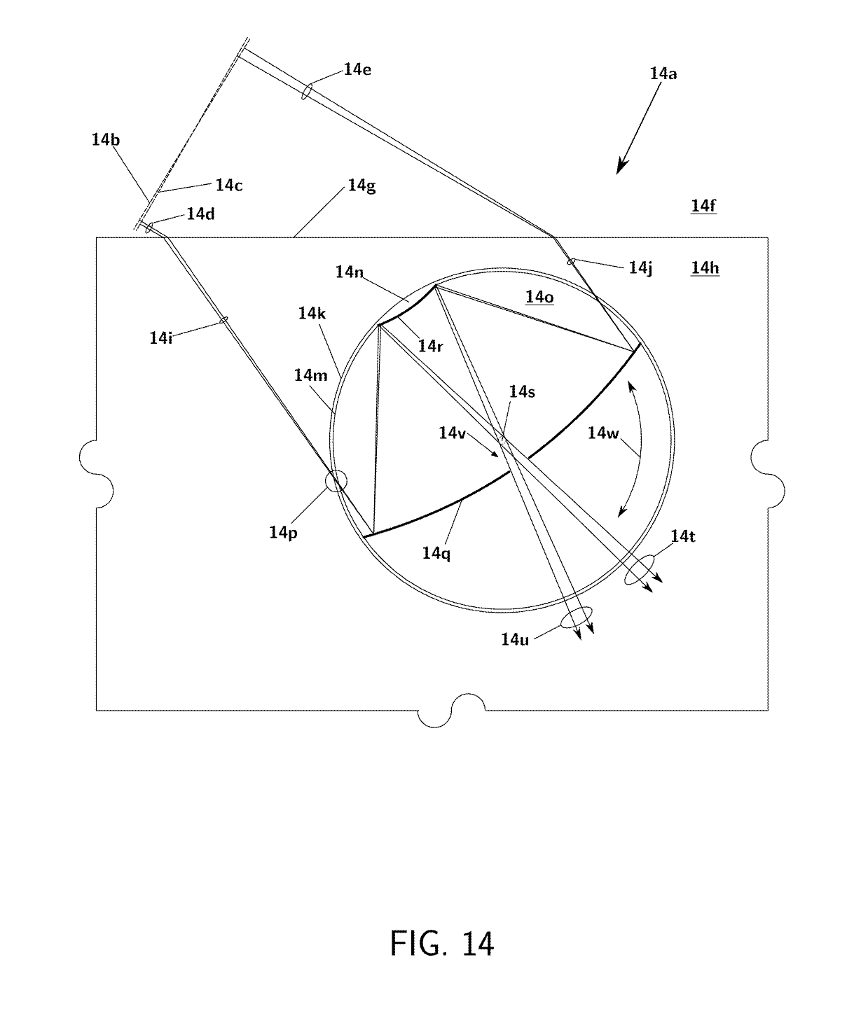

Next, some different embodiments for the optical elements are described. In particular, FIG. 14 show a system. 14a comprising a single rotor contained within a solid stator. Light from wavefronts 14b and 14c, which corresponds to the extreme edges of the solar disk (disk not shown) is propagated through the optical system. The two sets of edge rays 14d and 14e, comprising a total of four rays, are shown propagating in the air medium 14f and refracting at the tracker optical input surface 14g, this surface is formed by the stator, which has a stator medium 14h. After refraction at the tracker optical, input surface 14g the edge rays 14d transform into the edge ray 14i and the edge rays 14e transform into edge rays 14j all by means of refraction. Edge rays 14i and 14j then pass through a transition region formed between the stator's internal surface 14k surface and the outer surface of the rotor 14m. This transition gap 14n, which surrounds the rotor, comprises an index matching fluid that matches the refractive index of the stator 14h and the identical refractive index 14o of the rotor. That is to say the refractive index of the stator, index matching fluid, and rotor are identical or close to identical over the desired spectral band. The rays 14i pass undeviatecl through the gap at the transition region 14p then reflect at mirror 14q and then subsequently reflect at mirror 14r.

The resulting focal region can be identified by observing that the region 14s forms the region of minimal extent at the geometric center of the rotor after rays 14d and 14e are traced through the optical, system. Mirror 14r partially shadows the receiver and there is a tradeoff between the size of the focal region 14s and the extent of the mirror 14r. While an ideal point focus is not possible at the center of this (or any) rotor due to the non-xero angular extent of the sun, it is nonetheless possible to make the focus small enough so that a deflector redirects sunlight into an injector is possible. Mirrors 14q and 14r are close to conic sections but are not conic sections so that the focal region 14s can be made as minimal in spatial extent as possible due to a sun of non-zero angular extent. After passing through focal region 14s the incident rays 14d and 14e emerge from the stator as rays 14t and 14u respectively by means of the non-mirrored central portion 14v of mirror 14q. In this way the optical system of 14a tracks the sun by means of an externally applied rotation 14w and the focal region remains fixes at position 14s independent of the position of the sun.

It should be noted, that although the stator and rotor described above are solid materials and the index matching fluid is a liquid, it is also possible to make the stator a transparent container with thin solid walls and to have the internal stator material to be completely based on fluid to eliminate the need for machining a complex stator shape.

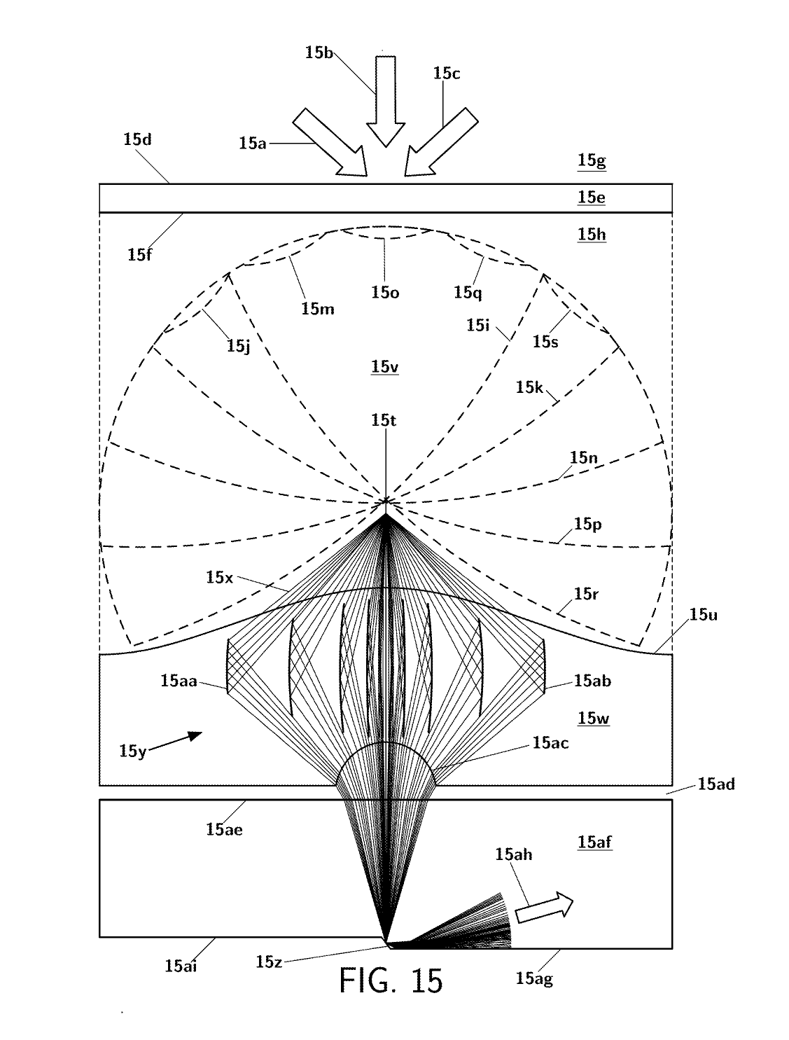

Consider FIG. 15, which shows a more detailed cross sectional image from FIGS. 7-8. Light from the sun may enter this section from any part of the sky. This is schematically represented by arrows 15a, 15b and 15c to show that morning, noon and afternoon sunlight may be received. The sunlight then refracts through the tracker optical input surface 15d, which is formed by the transparent material 15e having a surface 15f that is internal to the stator. In this way light may pass from the outside environment 15g, which is typically air, to refractive index matching fluid 15h. In this figure a number of different positions of the optical rotor are shown so that the full angular range of the motion of the rotor is graphically represented. Primary mirror 15i is paired with secondary mirror 15j. Primary mirror 15k is paired with secondary mirror 15m. Primary mirror 15n is paired with secondary mirror 15o. Primary mirror 15p is paired with secondary mirror 15q. Primary mirror 15r is paired with secondary mirror 15s. in this way sunlight always appears to have a source at the center of the rotor at point 15t. FIG. 15 only shows the rays emanating from the point 15t so that the figure is not cluttered with rays from different times of the day passing through the rotor. Also, note that the rotor never interferes with the first surface of the deflector 15u.

Continuing with FIG. 15. The index matching fluid 15h is matched to the refractive index of the transparent rotor 15v and the refractive index of the deflector 15w. A consequence of this is that a ray like 15x passes undeviated through the first surface of the deflector 15u. The sunlight then passes an array of deflector mirrors 15y. In this particular figure there are eight such mirrors, but more or less are possible depending on such parameters as the desired focus, position and width of the injector 15z, which is formed on a riser of the aggregator. The deflector mirrors 15y have curvatures that are opposite. For example deflector mirrors 15aa and 15ab curve in the opposite sense to each other. The deflector mirrors 15y are typically formed from either an air gap or from an embedded metal such as silver or aluminum.

The deflector also has a refractive surface 15ac, which refracts sunlight into the impedor gap 15ad. which is typically air and at a much lower refractive index than the deflector material 15w. The optical input surface 15ae of the aggregator, which is also know as its first surface, passes the light into the transparent aggregator medium 15af initially as it propagates toward the injector surface 15z. The injector then reflects the sunlight into the aggregator typically by means of TIR or by a metallic mirror. The light reflects off of the subsequent second surface of the aggregator 15ag as well as the first surface of the aggregator 15ae as it begins the process of propagating within the aggregator towards the receivor. The general direction of the sunlight is indicated by the arrow 15ah. Observe that the second surface of the aggregator has two parts called goings connected by a riser forming an injector 15z. The first going is 15ag the second going is 15ai and these are shown as parallel to the aggregator's first surface 15ae. Note that slight perturbation to the parallel nature of this geometry can help to optimize concentration and homogeneity of the sunlight striking the receivor. The thickness of the aggregator varies in a stepwise format as one moves along the aggregator towards the receivor.

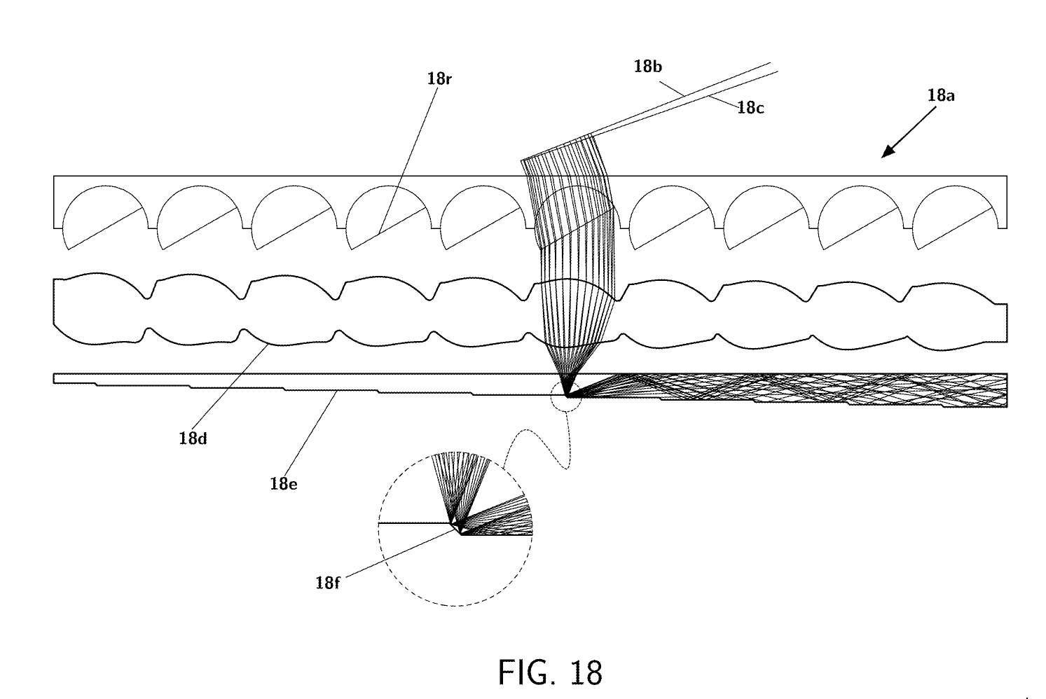

Next consider FIG. 18. which is an alternative rotor embodiment based only on refraction to form a virtual focus at the rotation center. In particular, a bundle of rays of direct incident sunlight 16a is incident on a stator medium 16b having first stator surface 16c, which forms the tracker optical input surface. The direct incident sunlight is refracted at the tracker optical input surface 16c and passes through the stator's second (internal) surface 16d. The stator's second surface 16d is seen in detail in the magnified view shown for a specific ray segment 16f from ray bundle 16a. In particular, ray segment 16e refracts into ray segment I6f, which refracts through the gap between the stator and the rotor 16g and emerges form the first surface of the rotor 16h as ray 16i. Said gap between said stator's second surface 16d and said rotor's first surface 16h may be a gas or liquid. An index matching liquid that minimizes the reflection losses at surfaces 16d and 16h is typical. If the stator and rotor are made from a transparent glass or plastic then the liquid will usually have a refractive index that is less than the refractive index of the stator and rotor by a small amount and minor corrections to the rotors first internal surface 16j may be required to compensate. Next, ray segment 16i refracts at the rotor's first internal surface 16j at point 16k and propagates towards a real focal point 16q, which Is never reached before being redirected.

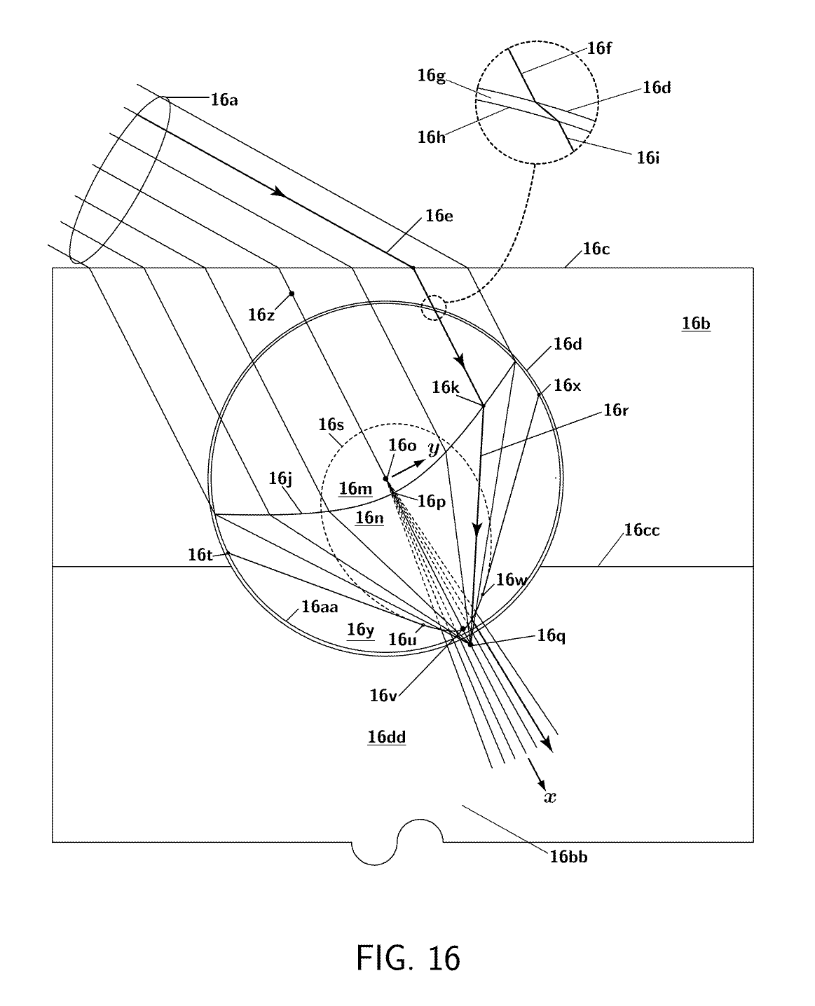

Consider a coordinate system, having its origin at rotor center 16o and attach said coordinate system to the rotor so that as the rotor rotates about 16o the coordinate system synchronously rotates along as well. The x-axis and the y-axis are as shown in FIG. 16 and labeled x and y respectively. Moreover, a hyperbolic curve, which defines the surface 16j internal to the rotor, is a function of: the first refractive index of the rotor 16m, represented by nᵣ₁; the second refractive index of the rotor 16n, represented by nᵣ₂; the location of the vertex 16p of said hyperbolic surface, represented by ν₁ along the positive x-axis; and the position of the first focus 16q along the x-axis, represented by ƒ₁. Application of Fermat's principle to focus the parallel rays, an example of which is ray 16i, to a common focus 16q produces four potential mathematically correct solutions from which the physically correct solution is found to b x as a function of y such that x=x(y) with parameters nᵣ₁, nᵣ₂, ν₁ and ƒ₁. Specifically

$$x = \frac{{A}_{1} - \sqrt{{B}_{1} \{ {C}_{1} + {n}_{r 2} ( - {v}_{1}^{2} + {y}^{2} ) + {n}_{r 1} ( {v}_{1}^{2} + {y}^{2} ) \}}}{{n}_{r 1}^{2} - {n}_{r 2}^{2}} \qquad ( 2 )$$

where

A₁=ƒ₁(nᵣ₁−nᵣ₂)nᵣ₂+(nᵣ₁ν₁−nᵣ₂ν₁)nᵣ₁ (3)

Bᵢ=(nᵣ₁−nᵣ₂)nᵣ₂² (4)

C₁=ƒ₁²(nᵣ₁−nᵣ₂)+2ƒ₁ν₁(−nᵣ₁+nᵣ₂), (5)

and n₁>nᵣ₂. In the case of a rotor that is cylindrical the hyperbolic curve is extended into the z direction (not shown) and in the case of a spherical rotor, half of the hyperbolic curve, from the vertex at 16p to the point of intersection with the rotors first surface 16h, is rotated about the optical axis by 2π radians (also not shown). Where the optical axis is defined as a line containing the line segment from the vertex 16p to the rotor's center 16o.

After refraction at the rotor's first internal surface 16j the ray segment 16i becomes the ray segment 16r. Ray segment 16r is further refracted at the boundary formed by a portion of the parametric curve 16s, which extends from starting point 16u, through to point 16v, and then to point 16w as one moves in a counter clockwise direction around the rotor's center 16o. Additionally, the region of the rotor formed below the curve defined by moving in a counterclockwise direction starting at point 16t. moving to point 16u, moving to point 16v, moving to point 16w and finally moving to point 16x. is the region characterised by the third refractive index 16y and is represented symbolically by nᵣ₃. The portion of the parametric curve 16s is chosen to refract rays coming from hyperbolic boundary 16j so that the rays have a virtual source that is ideally located at the cento- 16o of the rotor.

Application of Fermat's principle results in parametric curve 16s that is not a conic section. In fact it takes the shape of a nonstandard oval or teardrop and therefore shall henceforth be called a teardrop curve. Moreover, for certain parameters the teardrop curve may take the form of a toric section—a planar cut through a torus. The teardrop curve 16s is defined by the same coordinate system used to develop the hyperbolic curve 16j. The teardrop curve is characterized by: the refractive index of the rotor's second medium 16n, represented by nᵣ₂; the rotor's third medium 16y, represented by nᵣ₃; the vertex of the second boundary on the x-axis 16v, represented by ν₂; the position of the first real focus 16q along the x-axis, represented ƒ₁; and the position of the second virtual focal, point 16z, represented by ƒ₂. Observe, that point 16z is on the negative x-axis in FIG. 16 and therefore we must have ƒ₂≦0. Note, a common embodiment has the virtual focus of the rays at the center of the rotor 16o, so that point 16z coincides with point 16o, i.e. ƒ₂=0.

Analysis shows that to focus a ray 16r to a common virtual focus 16o requires a vector parametric function taking the form

r₂(ψ)= [symbol] ρ₂(ψ) cos ψ+ƒ₂, ρ₂(ψ) sin ψ [symbol] , (6)

where r₂(ψ) is the vector position of a point on the teardrop curve 16s as measured from the origin of the coordinate system at 16o, ρ(ψ) is the distance as measured from the virtual focus 16z to the point on the curve 16s and ψ is the polar angle as measured from the x-axis. The polar distance from the virtual focus is found to be given by

$${ρ}_{2} ( ψ ) = \frac{{A}_{2} + {B}_{2} cos ψ - \sqrt{{C}_{2} + {( {A}_{2} + {B}_{2} cos ψ )}^{2}}}{{n}_{r 3}^{2} - {n}_{r 2}^{2}} , \qquad ( 7 )$$

where,

A₂=nᵣ₃(ƒ₁n₂−ƒ₂nᵣ₃+ν₂(nᵣ₃−nᵣ₂)) (8)

B₂=nᵣ₂²(ƒ₂−ƒ₁) (9)

C₂=(nᵣ₃−nᵣ₂)(nᵣ₃²−nᵣ₂²)(ƒ₂−ν₂){2ƒ₁Nᵣ₂−ƒ₂(nᵣ₂+nᵣ₃)+ν₂(nᵣ₃−nᵣ₂)}, (10)

where nᵣ₃>nᵣ₂. Again, the reader is reminded that in a common embodiment the generalized virtual focus point 16z is moved to the center of the rotor at point 16o. This common embodiment, is shown in FIG. 16. That said, an example of a good reason that one might choose ƒ₂<0 is that this relaxes some of the constraints on the position of the deflectors and injectors making more room for subsequent optical stages. In general FIG. 16 refers to the situation where parameters are constrained by the relation −∞<ƒ₂≦0<ν₁<ν₂<ƒ₁≈R<∞, where R is the radius of the rotor.

The rays that refract across the teardrop boundary are then diverging from the virtual focus, which is usually taken as point 16o at the center of the rotor. A ray diverging away from the common point 16o is normal to the rotors second output surface 16d. Observe that the stator may be constructed from two materials. The first medium 16b and a second medium 16bb separated by a boundary 16cc. This allows the deflectors, injectors and aggregator to have a substantially different refractive index. Also, in the case when ƒ₂≠0 the rays are not necessarily normal to the stator's second surface 16d so that a different refractive index 16dd is useful to ensure that a virtual focus 16o, at the rotor's center, is still achieved. As before, the stator's transparent solid medium may be replaced by a transparent fluid medium.

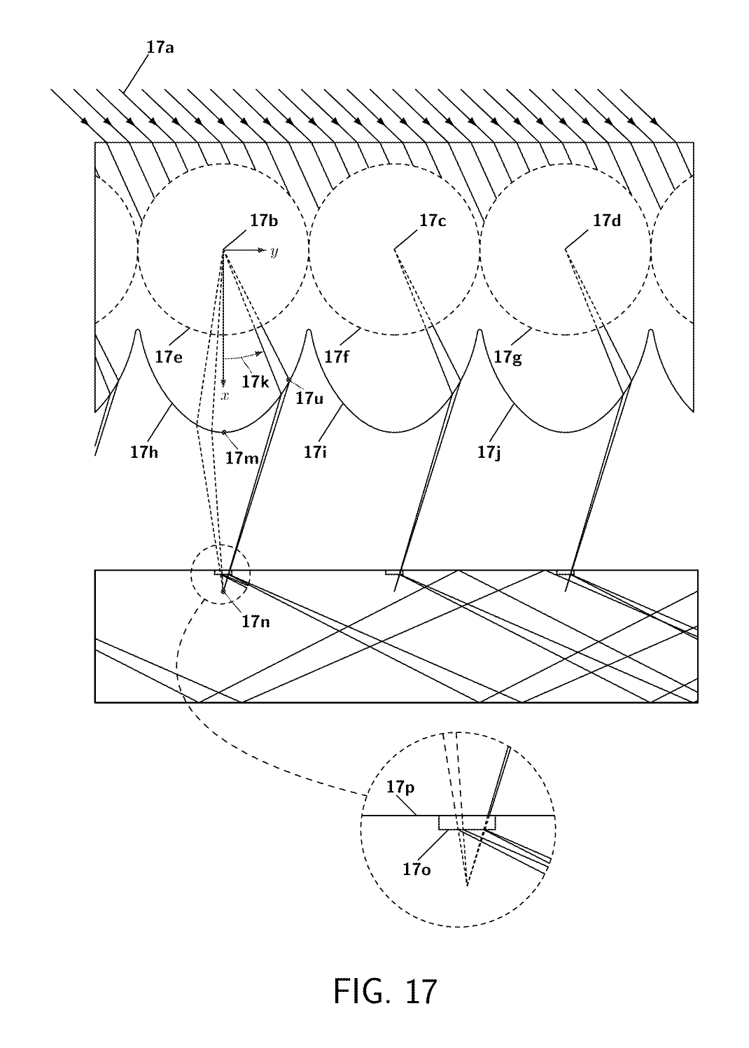

FIG. 17 shows a different embodiment of a deflector array. In particular, a portion of a solar panel comprising three complete rotors is shown and just as in previous embodiment the stator and the rotors work together to cause sunlight 17a coming from any direction above the stator to have a plurality of virtual sources located at the centers 17b, 17c and l7d of rotors l7e, 17f and 17g, Rays from the virtual sources are refracted by Cartesian Ovals 17h, 17i and 17j.

In this embodiment the specific form of the Cartesian Oval is given by fixing the origin at the center of eeach rotor, for example at 17b, with the x-axis being directed directly downward and the y-axis increasing towards the right as shown in FIG. 17. Let the polar distance from the rotor center 17b to the surface of the Cartesian oval be represented by ρ and the polar angle 17k as measured counter-clockwise form the x-axis be represented by θ. Furthermore, let the refractive index of the air gap between the stator and aggregator be represented by n_{g}, the refractive index of the stator be represented by nₛ, the x-axis coordinate of the vertex of the Cartesian oval 17m by ν₁ and the x-axis coordinate of the focus point 17n of the Cartesian oval as ν₂. Then the parametric equation representing the Cartesian oval in FIG. 17 is given by

$$\begin{matrix}r = ρ 〈 cos θ , sin θ 〉 , \\ where & ( 11 ) \\ ρ = \frac{{A}_{3} - \sqrt{{B}_{3} - {A}_{3}^{2}}}{{n}_{s}^{2} - {n}_{g}^{2}} , \\ and & ( 12 ) \\ {A}_{3} = {n}_{s}^{2} {v}_{1} + {n}_{s} {n}_{g} ( {v}_{2} - {v}_{1} ) - {n}_{y}^{2} {v}_{2} cos θ & ( 13 ) \\ {B}_{3} = {{v}_{1} ( {n}_{s} - {n}_{g} )}^{2} ( {n}_{s} + {n}_{g} ) ( {n}_{g} {v}_{1} - {n}_{s} {v}_{1} - 2 {n}_{g} {v}_{2} ) . & ( 14 )\end{matrix}$$

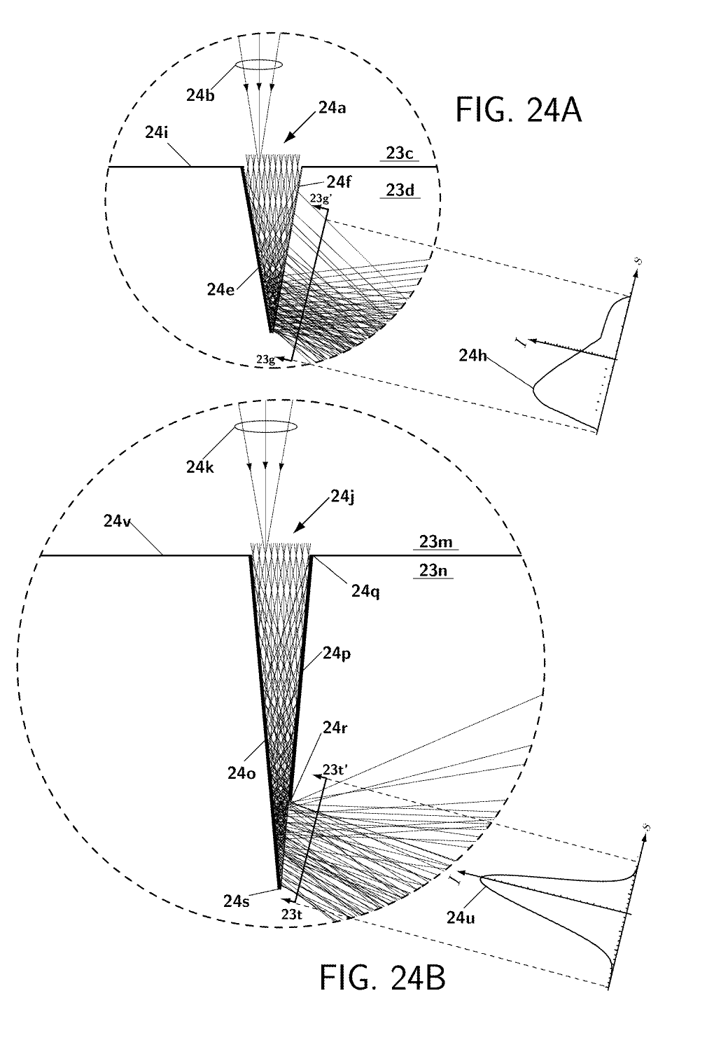

Therefore as the sun traverses the sky each day the rays are focused towards a single focal point 17n. However, before the rays can reach 17n they axe redirected by an injector 17o, which is represented as a schematic element here and located on an aggregator's first surface 17p. There are a. number of alternative embodiments for the injector an example is provided in FIG. 24A and discussed later in this document.

As was the case for the rotors the equations provided herein for the deflectors assume parallel rays for the direct incident sunlight and a perfect point focus at the center of each rotor. Therefore, the expressions for the deflector surfaces presented above need a perturbation correction to their shape to account for approximately 0.275 degrees of deviation is required at a minimum for optimum functionality. One way of obtaining these corrections is by numerical optimisation using the equations provided above as the starting point of a computer optimisation algorithm. Additional modifications to the deflector's shape can provide the focus I7n at the bottom of the aggregator instead of the top as shown.

Another embodiment of a deflector and associated optics is now considered. In particular, FIG. 18 shows in cross section a stator and rotor 18a based on the prior art of this author in U.S. Pat. No. 7,924,495, which is titled “Active Matrix sun Tracker”, This rotor has a virtual focus at infinity. Sunlight having edge rays associated with wavefronts 18b and 18c are shown propagating through one of said prior art rotors, which has been configured to accept light form, a particular direction, and is deflected by a deflector lens within the deflector array 18d. An example of one of the rotor's refracting surfaces is 18r. The deflector lens is designed so that the wavefronts are pre-distorted so that on passing into the aggregator 18e they may be focused onto the injector surface 18f. This then reflects the light into the aggregator in the direction of the receiver (not shown). The light remains trapped and is concentrated within the aggregator by means of TIR.

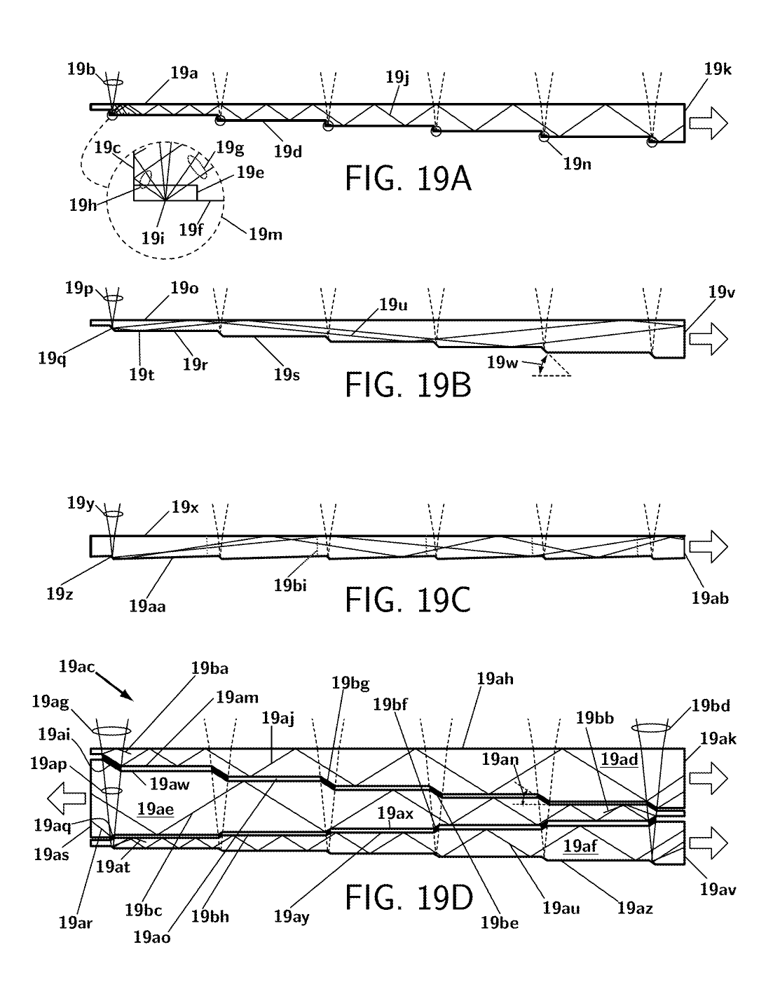

Next different aggregator embodiments are considered in. more detail. In particular, FIG. 19A shows an aggregator with a flat first-surface 19a receiving focused sunlight at ray bundle 19b, which is coming from a deflector (not shown). The flat first surface 19a is called the aggregator-optical input surface. The light from 19b passes into the transparent aggregator and focuses just to the right of a step discontinuity 19c in the second (lower) surfaces of the aggregator 19d. There the light is injected into the aggregator by an injector 19e, which is shown schematically as a “black box” in this figure. The injector 19e may be based on technologies that include, but; are not limited to: angular-band-limited diffusers, Graded Refractive INdex (GRIN) surfaces, blazed gratings and volume phase holograms. The injector injects the sunlight into the aggregator at step level 19f. The light may be directly injected as in ray bundle 19g or it may use the step discontinuity in refractive index at optical surface 19c to indirectly reflect ray bundle 19h by TIR into the aggregator. As already discusses the focal point 19i of the input ray bundle 19b is actually a region that fills up the area of the injector's input aperture. By the means just described the output light of the injector is sent propagating down the aggregator, through TIR based reflections, towards the optical output surface 19k, an example ray is shown as ray segment 19j.

FIG. 19A also shows a number of other input ray bundles, though they are not traced through the aggregator to keep ray clutter to a minimum. FIG. 19A shows these input ray bundles at equal spacing, however depending on the cut through a three-dimensional aggregator the spacing between the injectors may be non-uniform. The depth of the step changes how the aggregators profile are chosen so that light from preceding injector regions, e.g. region 19m, does not cross into the area of subsequent injectors, e.g. region 19n.

FIG. 19B shows another embodiment of a stepped aggregator. In particular, an aggregator with a flat first-surface 19o is receiving focused sunlight at ray bundle 19p, which is coming from a deflector (not shown). Surface 19o is considered to be a going of the top surface. The light from 19p passes into the transparent aggregator and focuses along an angled step discontinuity 19q, a riser, which forms an injector. In this way one level, or going, of the second surface of the aggregator 19r transitions to the neighboring level 19s, or going, of the second surface of the aggregator. Light that strikes an injector 19q is reflected into the volume of the aggregator. The reflection process may be by TIR or by use of a suitable mirror technology. A common embodiment providing an angled step transition that reflects all light by TIR, including TIR reflections 19t in the vicinity of the injector 19q. By this process a light ray 19u is sent propagating in substantially one direction within the volume of the aggregator towards the aggregator's output aperture 19v.

FIG. 19B also shows a number of other input ray bundles, though they are not traced through the aggregator to keep ray clutter to a minimum. FIG. 19B shows these input ray bundles at equal spacing, however depending on the cut through a three-dimensional aggregator the spacing between the injectors may be non-uniform. The depth and angle of the angled injector 19q are chosen so that light from preceding injector regions does not cross into the area of subsequent injectors. For this to occur it is desired that the elevation angle 19w, represented by ε, of the injector surface is

$$ε \geq \frac{1}{3} ( \frac{π}{2} + θ ) \qquad ( 15 )$$

where θ is half of the focal angle of the ray bundle 19p as measured at the focal point and within the transparent dielectric of the aggregator and where all angle units are in radians.

FIG. 19C shows a variation of embodiment of FIG. 19B wherein the step discontinuity of the injector is readjusted back to the original level. Its advantage is that it remains of uniform average thickness. In particular, an aggregator with a flat first-surface 19x is receiving focused sunlight at ray bundle 19y, which is coming from a deflector (not shown). The light from. 19y passes info the transparent aggregator and focuses along an angled step discontinuity 19z, which forms an injector. In this way one level of the second surface of the aggregator transitions to the neighboring level of the second surface of the aggregator. However, unlike the embodiment of FIG. 19B this embodiment has the second surface 19aa at a slight angle to readjust the low level back to the original level of the second surface of the aggregator. If the elevation angle of surface 19aa relative to the horizontal is represented by α then a ray that is internal to the aggregator, making an angle of θ₀ to the horizontal, will change its angle relative to the horizontal by

θₘ=θ₀+2mα (16)

where m is the number of reflections that occur. This allows for a flatter aggregator especially when the angle α is small so that propagation is maintained by TIR even as the ray moves closer towards the TIR critical angle as it moves towards the aggregator output aperture 19ab.

FIG. 19C also shows aggregator segmentation, for example 19bi, which shows where changes of the refractive index from one aggregator segment to the next may optionally occur. Within each aggregator segment the refractive index is a constant. However, as the light moves down the aggregator, from left to right in FIG. 19C, the refractive index can make monotonically increasing step changes. This has the effect of increasing the étendue as one moves along the aggregator. This is necessary to at least partially compensate for the increasing value of θₘ. Clearly, between aggregator sections we see that the angle of a ray relative to the horizontal is

$${θ}_{{m}^{′}} = {sin}^{- 1} [ ( \frac{{n}_{m}}{{n}_{{m}^{′}}} ) sin {θ}_{m} ] < {θ}_{m} \qquad ( 17 )$$

where the refractive index of the subsequent section nₘ, is greater than the refractive index of the current section nₘ so that the refracted angle decreases to compensate for the increasing angle θₘ, which is due to non-parallel surfaces 19aa and 19x.

FIG. 19D shows an embodiment for a multi-spectral-band aggregator wherein different wavelength bands are separated and propagate within separate sub-aggregators. The embodiment shown in FIG. 19D shows an aggregator that is divided into three separate bands so that the output of each sub-aggregator is matched to a photovoltaic cell having a narrow spectral band that is highly optimized. For example, the solar spectrum is dominant over the wavelength range of about 300 nm to 1,800 nm and individual solar cells may be optimised to cover the bands from 300 nm run to 600 nm; from 600 nm to 900 nm; and from 900 nm to 1,800 nm so that out-of-band losses are minimized in each solar cell. In this way the solar cells can be optimised for higher efficiency. The embodiment of FIG. 19D also allows more bands to be added if desired simply by adding more sub-aggregators to the aggregator.

Specifically, FIG. 19D shows an aggregator 19ac having three sub-aggregators comprising transparent media: 19ad for the first sub-aggregator, 19ae for the second, sub-aggregator and 19af for the third, sub-aggregator. Ray bundle 19ag refracts through the first-surface 19ah of the first sub-aggregator and the first spectral band is reflected into the volume of the first sub-aggregator by dichroic mirror 19ai, which acts as an injector for the first spectral-band. Energy from the first spectral band is thus reflected into the first sub-aggregator as depicted by ray 19aj. This energy propagates to the first optical output surface 19ak of the first sub-aggregator by means of TIR between the first surface of the first sub-aggregator 19ah and the second surface of the first sub-aggregator 19am. The elevation angle of the dichroic mirror 19ai is given by Eq. 15, this angle is depicted in general as angle 19an. In particular FIG. 19D shows the case when the equality of Eq. 15 holds. Additionally, as depicted, there are a plurality of dichroic mirror based injectors along the aggregator. FIG. 19D shows these injectors equally spaced, but they may be aperiodic if the cross sectional cut is taken in a different plane from a three dimensional solar panel.

It will often be more convenient to talk about the stepped structure in FIG. 19 in terms of the going and the riser forming the steps. By way of example FIG. 19B has a large going 19o and a plurality of goings, such as 19r and 19s on the opposite side. The minimum number of goings for an aggregator are two, which form opposite sides of an aggregator. Another example of a riser is 19bg. Both goings and risers may be formed on opposite sides of the aggregator, this is especially obvious in FIG. 19D, which has each sub-aggregator with steps on each side and the risers of the steps forming the injectors.

Each injector section is formed on an angled section, the riser, of either the first-surface of a sub-aggregator or the second-surface of a sub-aggregator. Moreover, each injector fills the space 19ao between two neighboring sub-aggregators. This space 19ao in general forms an impedor unless it is filled by the structure of an injector. The injector thus forms a bridge between two neighboring sub-aggregators. The injectors being formed by dichroic mirrors having an elevation angle 19an are thus able to separate different spectral bands into different sub-aggregators. Thus the broadband solar energy in ray bundle 19ag is reduced in bandwidth by injector 19ai. The first spectral band being reflected into medium 19ad and the second and. third spectral bands being transmitted by the dichroic mirror into the second sub-aggregator as ray bundle 19ap having transparent medium 19ae.

The second and third spectral bands are further separated by another injector 19aq, which reflects the second spectral band into ray 19ar. The second spectral band propagating towards the optical output surface 19as of the second sub-aggregator. Additionally, the injector 19aq passes the third spectral band into the transparent medium 19af of the third sub-aggregator and this energy travels down the third sub-aggregator, as depicted by rays 19at and 19au, towards the optical output surface 19av of the third sub-aggregator.

The propagation of the first spectral band in the first sub-aggregator is supported by TIR between the first and second surfaces, 19ah and 19am respectively, of the first sub-aggregator. The propagation of the second spectral band in the second sub-aggregator is supported by TIR between the first and second surfaces, 19aw and 19ax respectively, of the first sub-aggregator. The propagation of the third spectral band in the third sub-aggregator is supported by TIR between the first and second surfaces, 19ay and 19az respectively, of the first sub-aggregator. Exples of ray propagation in the first sub-aggregator include rays 19ba and 19aj, which come from input ray bundle 19ag. Examples of ray propagation in the second sub-aggregator include rays 19bb and 19bc, which come from input ray bundle 19bd. Examples of ray propagation in the third sub-aggregator include rays 19at and 19au, which come from input ray bundle 19ag.

In general the widths of injectors associated with the same input ray bundle are not the same. This is easily seen by comparing injectors 19be and 19bf. In general the widths of injector associated with neighboring input ray bundles are not the same. This is easily seen by comparing injectors 19be and 19bg.

The first and second sub-aggregators are separate by an gas or vacuum gap 19ao, which forms an impedor between neighboring aggregators. The second and third sub-aggregators are separate by a gas or vacuum gap 19bh, which also forms an impedor between neighboring aggregators.

The direction of propagation of spectrally band-limited solar energy is alternating by 180 degrees in corresponding alternating aggregator layers as indicated by the three large 2-dimensional closed-loop arrows in the figure.

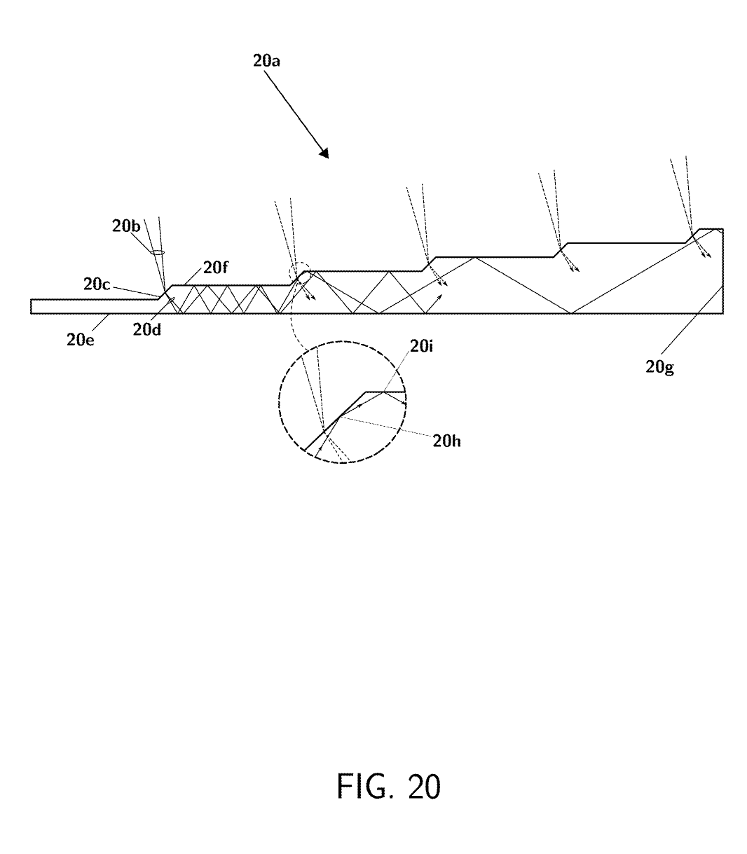

An alternative embodiment for an aggregator is shown in FIG. 20 with an aggregator having integrated injectors 20a that are based on refraction. Edge rays 20b are refracted at injector input surface 20c and transformed into edge rays 20d, which then reflects between the aggregator's second surface 20e and the aggregator's first surface 20f. Rays are maintained within the aggregator by means of TIR and propagate towards the optical output surface 20g. Any rays that might intercept a portion of a subsequent injector are forced to remain within the aggregator by TIR. This is seen as the TIR at points 20h and 20i The radiation from a number of other injector input ports is shown in the figure as well. but the rays from those ports are not traced to reduce clutter in the figure.

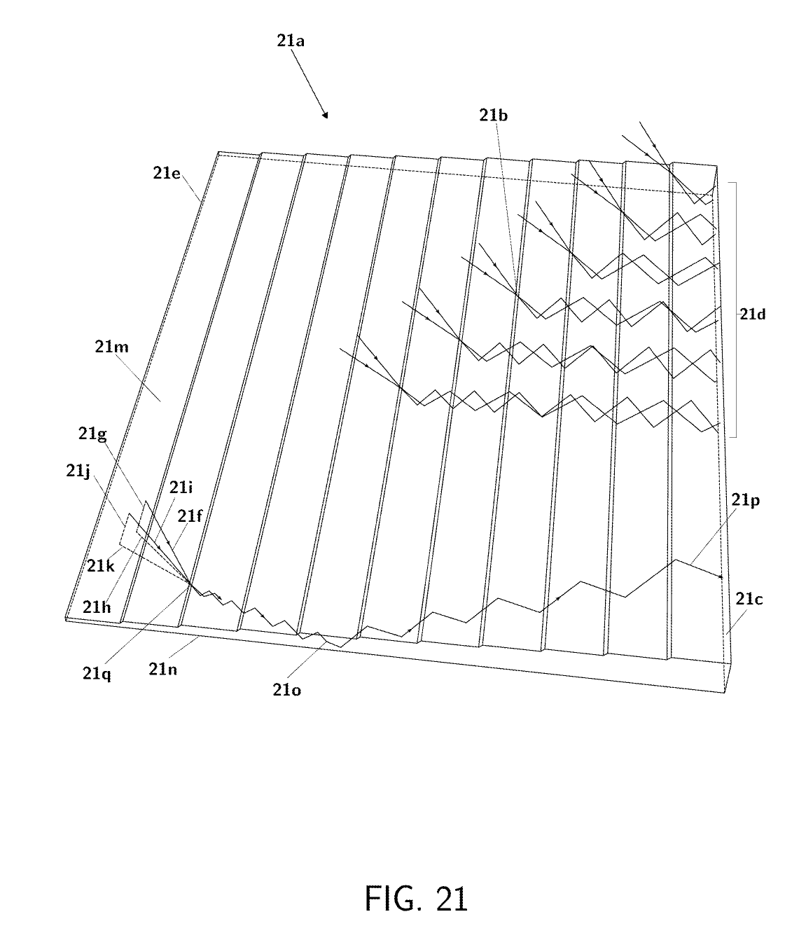

FIG. 21 shows a three dimensional version of FIG. 20 in a perspective view. In particular, 21a is an aggregator with integrated injectors that are based on refraction. Light entering an injector input surface at point 21b propagates towards the aggregator optical output surface 21c. The rays that are intercepting the aggregator optical output surface at region 21d have no component of the optical momentum in the north-south direction, where the north-south direction is parallel to the aggregator edge 21e. Typically edge 21e would be considered to be on the east side of the aggregator and the aggregator optical output surface 21c on the west edge.

That being said, it becomes obvious that there would be a component of the incident optical momentum that is parallel to edge 21e if the solar panel is placed flat on the ground. In the case of a solar panel placed flat on a level ground in the northern hemisphere of Earth the optical momentum component would be directed toward the northerly direction. This is shown in vector form in FIG. 21 by means of an aggregator-incident edge ray 21f, which is broken into components having a northerly direction 21g and a vector with a westerly component 21h. Another incident edge ray 21i is also shown and it has a northerly component 21j of the optical momentum and a westerly component 21k. Both edge rays are incident at point 21q. Refraction of these incident rays through an injector input surface causes the rays that are internal to the aggregator to also have a northerly directed optical momentum component. This forces the light ray shown to not only reflect from the aggregator's first optical surface 21m and second optical surface 21n, but also to reflect off of the northerly edge of the aggregator at point 21o as it works it way by TIR to the aggregator optical output surface 21c via ray 21p. The reflection at point 21o may be due to a mirror coating or by TIR within the aggregator.

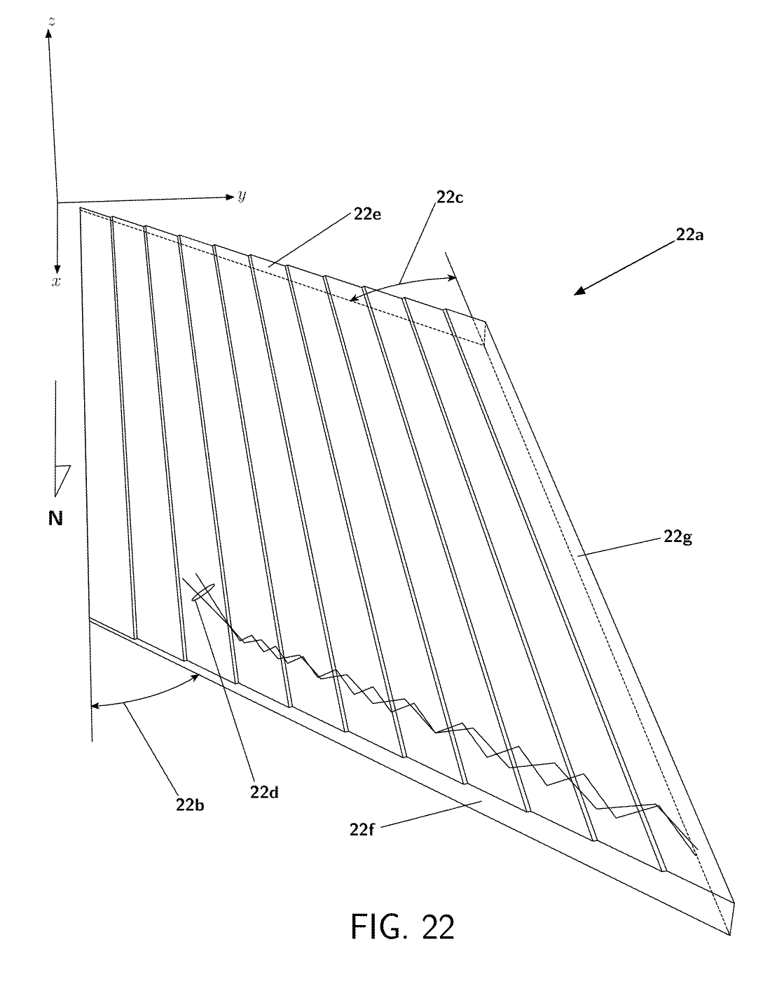

The rectangular geometry of an aggregator, and by extension a solar panel, which is described in FIG. 21, is not the only possible embodiment. The geometry of FIG. 21 requires reflections off of the more northerly side of the aggregator for a solar panel array located in the northern hemisphere of the Earth. With that in mind consider the alternative geometry shown in FIG. 22 wherein the rectangular or square shape has been reconfigured into a parallelogram. The parallelogram aggregator and injector system 22a has its east-west edges at angles of 22b and 22c from lines that are parallel to the x-axis shown. Angle 22b is typically taken to be equal to angle 22c to form a parallelogram.

The edge rays injected into this aggregator now are parallel to the aggregator edges 22e and 22f when the Earth is at the summer and winter equinox positions in its orbit. When the Earth moves from the summer equinox to the winter solstice the sun gets low in the local sky and the edge 22f is the first edge to get illuminated internally to the aggregator. When the Earth moves from the winter equinox to the summer solstice the sun gets high in the local sky and the edge 22e is the first edge to get illuminated internally to the aggregator. Edges 22e and 22f may be mirror coated, or left to provide TIR to the light incident or be configured with a diffuser, especially an angular-band-limited uniform diffuser, that spreads and homogenizes the intensity of the light redirected towards the aggregator's optical output surface 22g.

The use of a parallelogram shaped solar panel, a thin aggregator having refractive index of about 1.80, and a constantly readjusted aggregator step slope, e.g. FIG. 19C to keep the aggregator compact and at the limits of concentration, can achieve a concentration of about 375 suns using only 1-DOF for tracking. Moreover, the solar panel can be laid flat on the ground and cover most of the area allowing for a very efficient use of the supporting land or roof area.

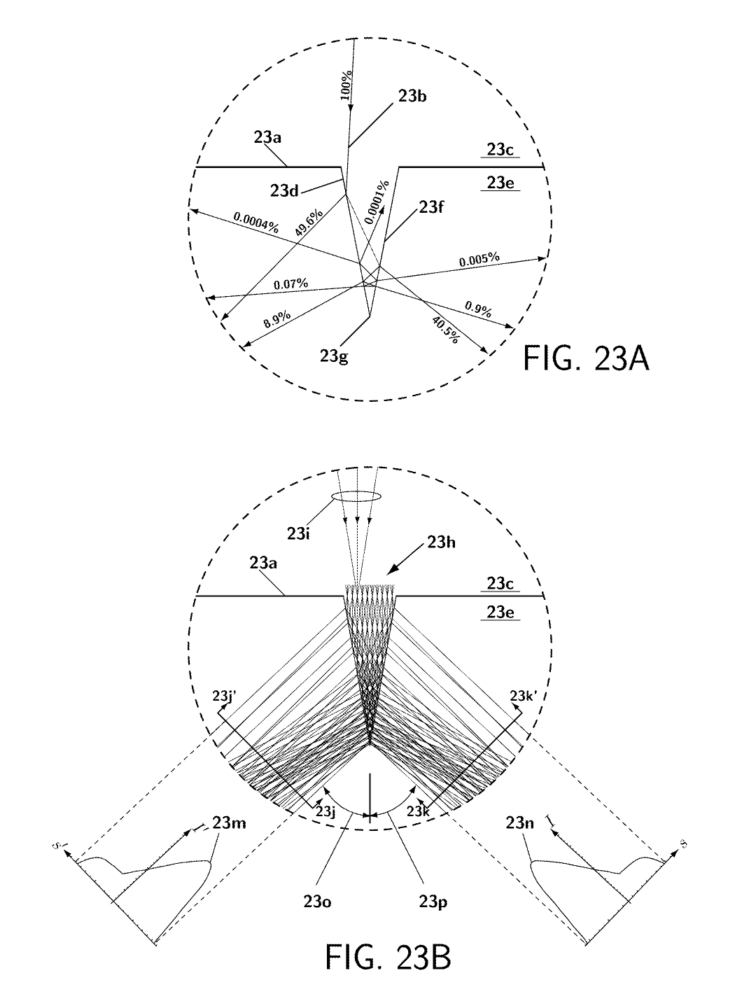

FIG. 23A shows an alternative embodiment for an injector that is based on forming a deep groove, for example by laser machining, in the input surface 23a of an aggregator. As an example of ray propagation therein consider an s-polarized ray 23b in a first medium 23c, which is typically air, entering the injector striking a first internal injector surface 23d and being partially refracted into the aggregator's transparent medium 23e and partially reflected deeper into the groove. The input ray is characterized by an intensity of 100% before it interacts with the first internal injector surface. After the first refraction the ray has about 49.6% of its intensity propagating in the aggregator substantially towards the left. After the second refraction at the second internal injector surface 23f and additional 40.5% of the original intensity is propagating within the aggregator, but substantially towards the right. Additional reflection and refractions continue until the ray has reversed direction and exited the deep groove, but with an intensity that is 1,000,000 times smaller than its input intensity. Thus as the ray moves from the surface level of the aggregator towards the apex 23g of the injector grove the light is essentially squeezed out of the injector into the aggregator at sufficiently steep angles that allow the aggregator to support TIR. A very similar situation occurs for p-polarlzed light and all other mixed polarization states.

FIG. 23B shows the situation with an extended bundle of rays 23h at the entrance aperture of the injector. The bundle of rays is composed of a number of smaller ray bundles, such as 23i, providing three rays at each point of the entrance aperture: two edge rays and one ray parallel to the symmetry axis of the injector. The result of a numerical ray trace is shown for thousands of rays passing through two mathematical surfaces (“screens”). The first surface is defined by screen 23j-23j′ and the second surface is defined by screen 23k-23k′. The corresponding intensity plots for I and I′ as a function of position s and s′ respectively, which include the effects of partial Fresnel refractions, are provided in plots 23m and 23n. These plots show intensity that varies as a function of position and propagation at angles 23o and 23p which will support TIR within the aggregator medium 23e.

There are a number of important variations of the injector embodiment of FIG. 23B that allow asymmetric light injection into the aggregator, better control over the intensity distribution, and a reduced profile to scattering light out of the aggregator that is already propagating within the aggregator.

In particular, FIG. 24A shows a ray bundle 24a filling the input aperture of an injector using sub ray bundles, such as 24b, comprising two edge rays and a paraxial ray. The input medium is 24c and the aggregator medium is 24d. The first internal injector surface 24e is now a mirror. For maximum efficiency one common embodiment provides an ultra-low loss multi-layer dielectric mirror. An alternative to the dielectric mirror is a metallic mirror. Additional alternatives including interference optics like volume holograms, photonic crystals and gratings.

Subsequent to the reflection from the first internal injector surface 24e the rays partially refract and partially reflect off of the second internal injector surface 24f to yield an asymmetric distribution of light in the aggregator. This is quantified at the screen 24g-24g′ as shown in the intensity plot 24h. Note that as in FIG. 23B the injector input aperture in FIG. 24A is formed at the same level as the first optical input surface of aggregator 24i.

FIG. 24B shows a ray bundle 24j, which is filling the input aperture of an injector and using several sub-bundles, such as 24k, comprising two edge rays and a ray parallel to the vertical. The input medium is 24m and the aggregator medium is 24n. The first internal injector surface 24o is a mirror. For maximum efficiency one common embodiment providing an ultra-low loss multi-layer dielectric mirror. An alternative to the dielectric mirror is a metallic mirror. Additional alternatives including interference optical elements like volume holograms, photonic crystals and gratings. Also note that in an alternative embodiment the injectors are filled with a transparent dielectrics other than air to protect the mirrors therein and increase the angular acceptance angle.

Subsequent to the reflection from the first internal injector surface 24o the rays completely reflect off of the second internal injector surface 24p, which is a mirrored surface from point 24q to point 24r. From point 24r to point 24s there is no mirror and the light may refract into the aggregator. The result is an asymmetric distribution of light in the aggregator. This is quantified at the screen 24t-24t′ as shown in the intensity plot 24u. The intensity plot shows that the distribution of light is very similar to a Gaussian curve, which is explained by both the position of the rays exiting the injector and the Fresnel transmlttance intensity of each ray. Note that as in FIG. 24A the injector input aperture in FIG. 24B is formed at the same level as the first surface of the aggregator 24v.

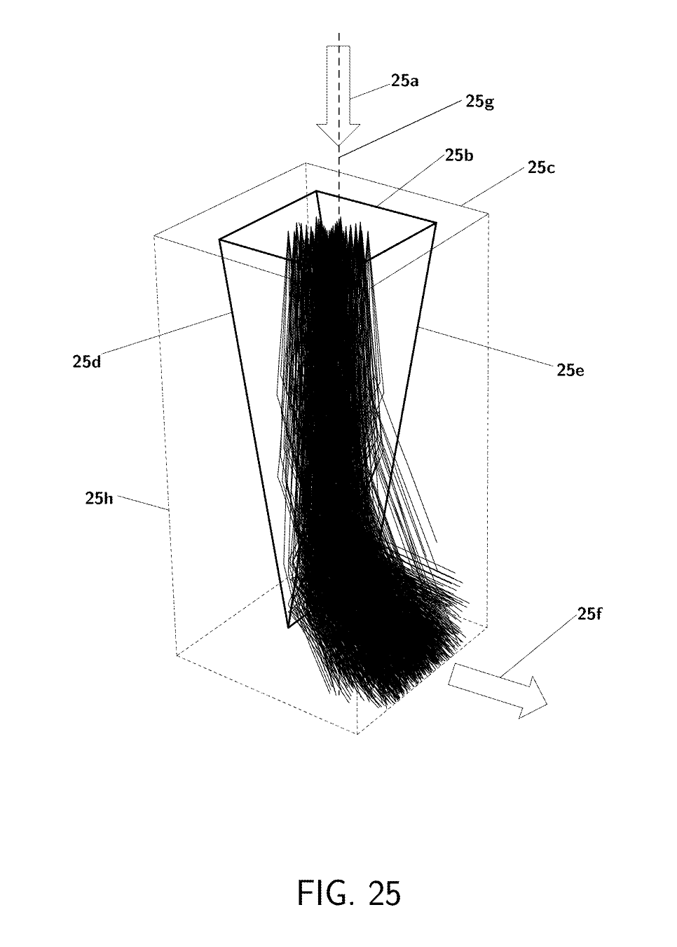

FIG. 25 shows a three dimensional perspective of a wedge-shaped injector similar to that shown in cross section in FIG. 24B. Incident sunlight 25a is focused by a deflector (not shown) onto the injector input aperture 25b. The input aperture is formed directly in the first surface of the aggregator 25c, i.e. the aggregator optical input surface. The three dimensional geometry of the injector is also shown as being formed by flat surfaces (other shapes are possible and often desirable) and this is indicated, for example, by the straight edges 25d and 25e that extend into the aggregator material. In this way the light is ultimately injected into the aggregator in a very specific direction 25f, which we shall call the injection direction. Note that individual light rays are shown propagating within the injector structure in three dimensions. Also note that the injection direction 25f is easily controlled by rotating the injector cone about its longitudinal axis 25g. The depth of the injector is indicated by the line 25h and it is typically a small fraction of the thickness of the aggregator to minimize leakage. Thus the scattering cross section of the injector to light that is already within the aggregator and propagating toward the receiver is small.

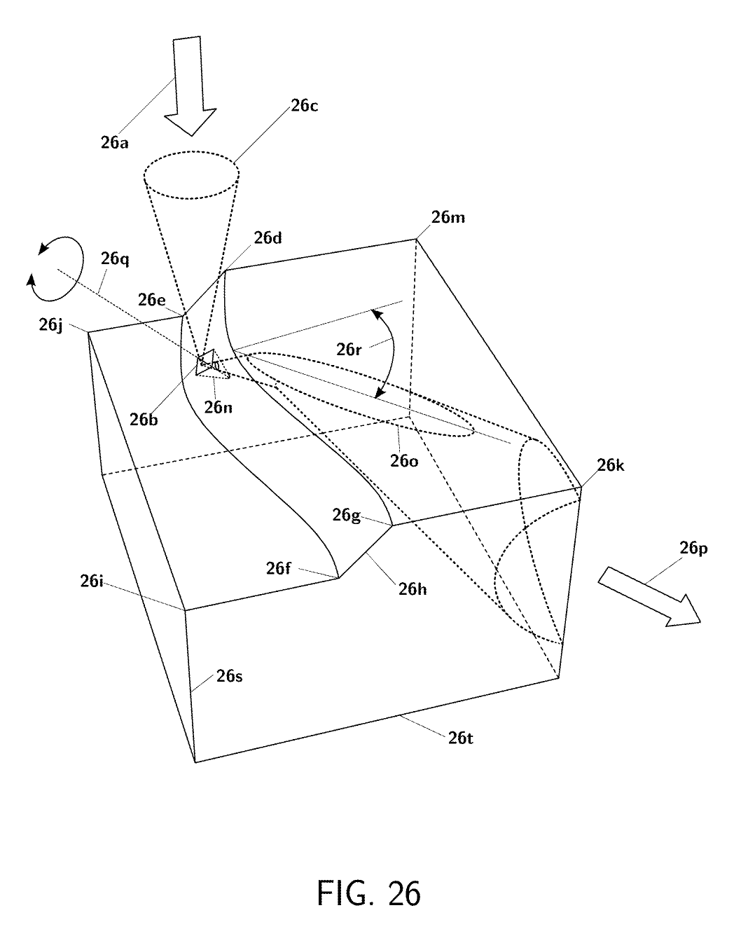

Next consider FIG. 26, which shows incident light 26a propagating towards an injector input aperture 26b. The incident light having been focused by a deflector (not shown) takes the from of a converging cone of light 26c. The injector aperture is located flush on the step transition. The step transition is a surface which is defined by the points 26d. 26e. 26f, and 26g, and is also called the riser. In FIG. 26 the step transition is not a simple flat surface, but rather a complex curve. In certain embodiments of the solar panel this is important as it allows the deflector array to not be limited by the geometry of a rectangular grid. The deflector array now being formed on a more general set of curves that allow greater control of injection of light into the aggregator. An edge of the step transition is shown as 26h. A portion of a lower step of the aggregator's first surface is defined by the points 26e, 26f, 26i and 26j. A portion of au upper step of the aggregator's first surface is defined by the points 26d, 26g, 26k and 26m. The injector is shown as a void in the step transition and shaped for its job.

While there are quite a variety of shapes that are possible a simple embodiment is shown here. In particular, it is the shape of a tiny four-sided air-medium pyramid 26n that is embedded within the transparent aggregator. The injector has as many as three of its sides mirrored and the last side is not mirrored. The incident cone of light 26c reflects off of the mirrored internal surface of the injector and bounces within the injector, similar to that shown in FIG. 23. Only one bounce is depicted in FIG. 26 due to the scale of the figure constraining stick details. The light that refracts through the output surface of the wedge-shaped injector strikes the first surface of the aggregator in an approximate ellipse 26o and reflects by TIR back into the volume of the aggregator in direction 26p.

The direction of the light, as projected onto said upper step of the aggregator, and defined by said approximate ellipse 26o can easily be changed by rotation of the pyramid inset shape of the injector about its symmetry axis 26q when it is initially fabricated, so that the direction of the propagation is generally offset by an angle 26r. The ability to easily adjust the direction of light injection into the aggregator during fabrication allows the aggregator to not only provides a means to guide radiant energy, but also to concentrate the energy as well because all the injectors of a solar panel can essentially point towards the same output location on the panel. The depth of the aggregator shown 26s is only a small portion of the depth of the total aggregator. The length of the aggregator shown is 26t and it is only a small portion of the length of the total aggregator—the rest of the aggregator is not shown in this figure. There may be many hundreds of injectors on a solar panel and each may have a different shape and orientation. The formation of the injectors is done by a number of different manufacturing processes including laser machining and micro-forming of injector surfaces to form angular band limited diffusers to control the angular dispersion of the processed light.

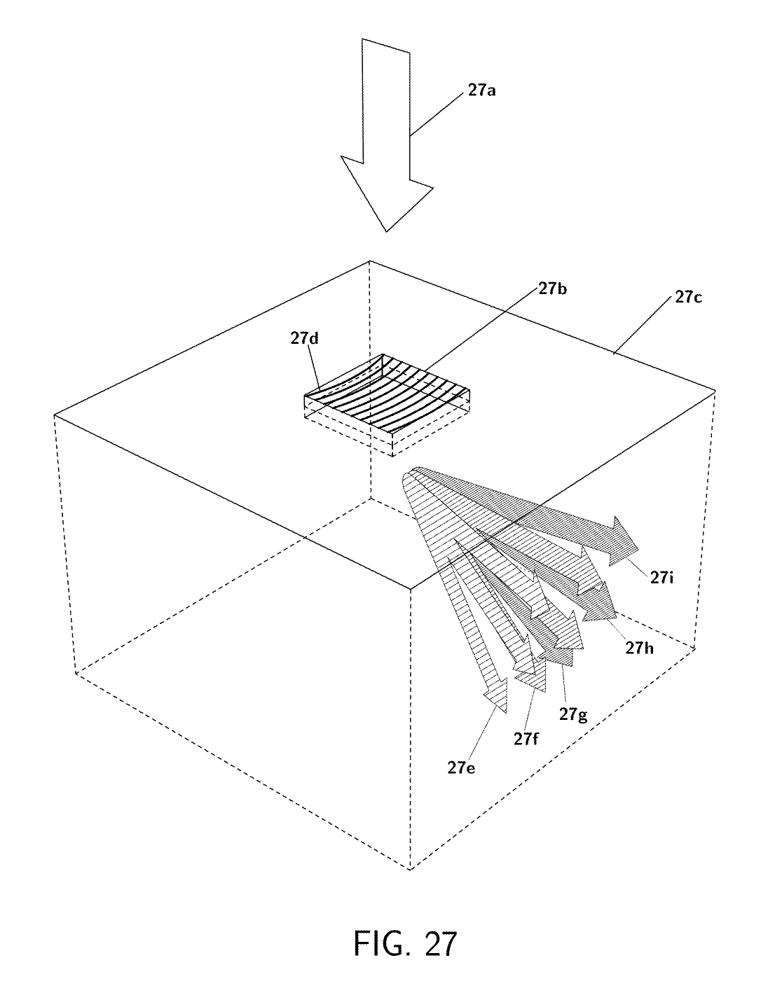

Another injector embodiment is shown in FIG. 27, wherein sunlight 27a is incident on an injector 27b that is located on the first surface of an aggregator 27c. This surface is also called the aggregator's optical input surface. The injector is manufactured as an integral part of the aggregator or as an adjoined device. The injector here is similar to FIGS. 23-26, wherein a deflector focuses sunlight onto a very small spot on or about the surface of the aggregator and then deflects the light into a particular direction with an angular spread. The angular spread decreases the intensity of the light energy as it moves away from its injecting injector to minimize leakage by scattering out of other injectors.

This injector may be on the aggregator's first surface or on its second (bottom) surface, but the point is that the injector takes up very little aggregator area. The injector shown in FIG. 27 also shows a patterned surface 27d (not to scale) that asymmetrically injects energy into the aggregator. For example the patterned surface ridges 27d represent the fringes of a thick film holographic grating or the locations of randomly patterned lenselets forming an angular-band-limited diffuser. Such a diffuser made from lenselets having a diamet of 50-100 microns is not sensitive to the wavelength of the sunlight. Moreover, the pattern may be manufactured using lasers or nano- or micro-imprinting technologies, which are suitable for mass production.

The output of the injector 27b is spread angularly both left and right, as shown schematically by arrows 27e, 27f and 27g; and up and down as shown by arrows 27g, 27h and 27i. The direction of this light is such that it remains predominately trapped within the aggregator, even though the aggregator is a leaky-wave structure having localized regions where other injectors are formed. The directionality of the injected energy can be controlled by adjusting the structure of the injector patterning. This will allow a large number of injectors to focus at the same location from many different positions on the solar panel.

Note, if one is willing to use two or more solar ceils on the solar panel then the constraint for using asymmetric injection into the aggregator is lifted and the formation of the optics becomes even easier. This is desired if the injector 27b separates the light into spectral bands that are directed into different directions.

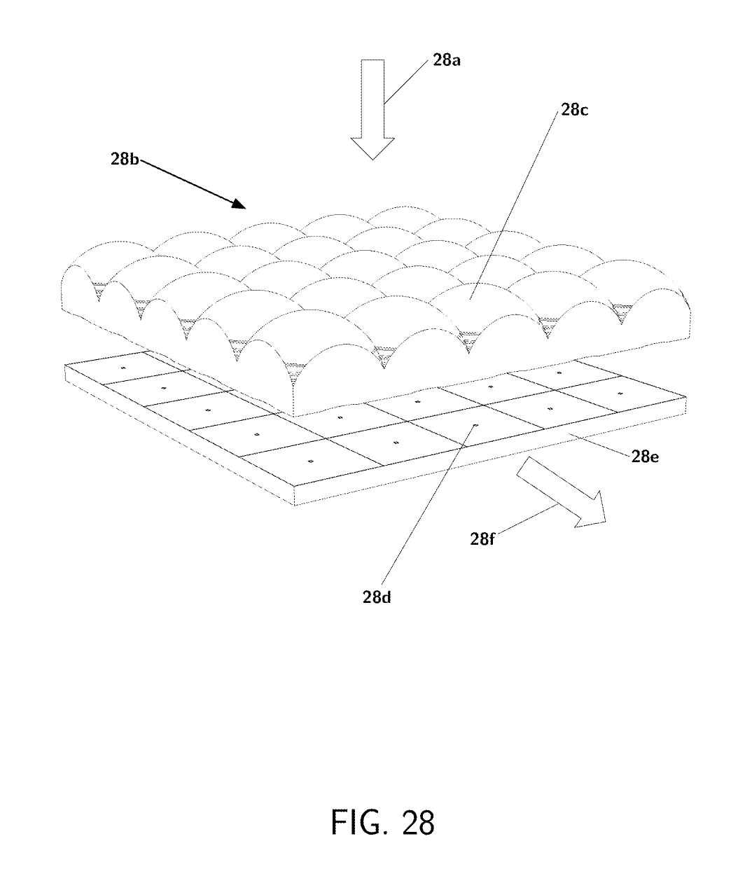

FIG. 28 shows incident sunlight 28a illuminating a three dimensional deflector lens array 28b having injectors at each deflector focal point on the aggregator. An example of an individual lens element is 28c and an example of an individual injector is 28d. The injector's input aperature is very small and is at the focus of the deflector lens 28c. The injectors are configured so that they have an injection direction that focuses the light to a receiver (not shown) by retaining and propagating the sunlight within the aggregator 28e. The direction of the propagating sunlight is shown by the arrow 28f. The deflector array may take many forms, but the essential feature is that the light is focused to small injector apertures and the injection direction is controlled to both trap the light within the aggregator and to focus it onto a receivor. It is also possible to have reflective type injectors on the bottom of the aggregator 28e, e.g. a structure similar to FIG. 27, but with the injector on the aggregator's second surface not its first surface.

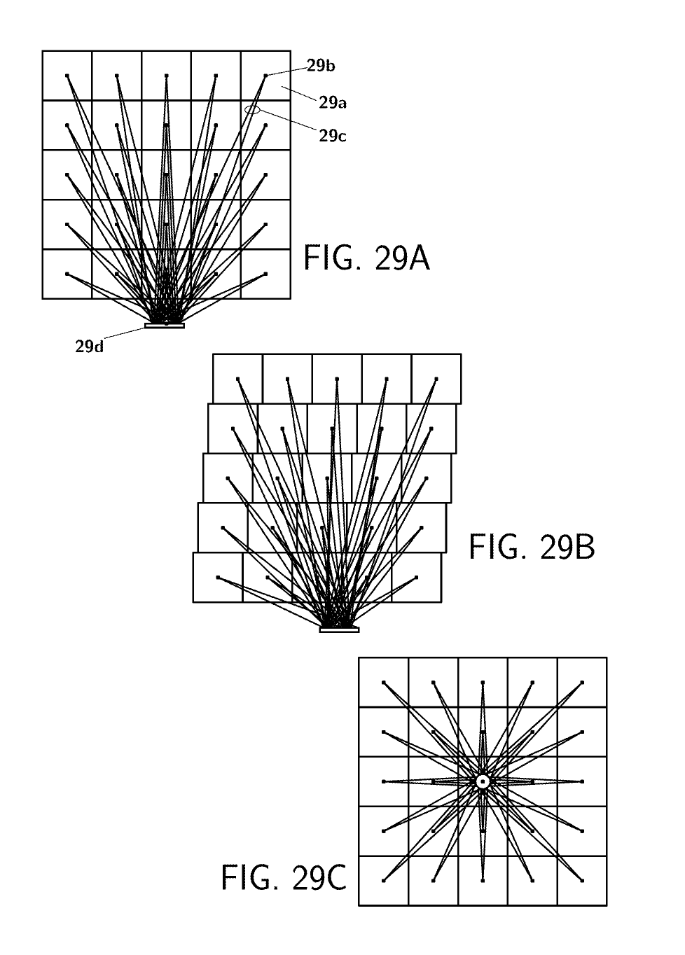

The FIGS. 29A-C provide examples of how controlling the injection direction within an aggregator can focus the sunlight on a receivor. In particular, FIG. 29A shows a portion of the solar panel from FIG. 28 as seen from the top looking down. The section contains a grid of five by five squares that define individual deflector lenses. An example of one square region is 29a. Also, shown are the individual injector apertures. An example of an injector aperture is 29b. Each of the injectors injects its received sunlight into a specific direction called the injection direction. The injection direction is actually a range of directions that tend towards an average. This may be thought of heuristically as the beam from a flash light and has direction and angular width. This is shown schematically in FIG. 29A by means of a beam of light emanating from the injector. An example of this is shown as the ray bundle 29c, which is graphically represented by two rays that show the extent of the output of the injector. Each of the injectors of the solar panel are configured to send its sunlight towards the solar panel's receivor 29d. If the injector area and depth of penetration into the aggregator is kept small the amount of scattering of light back out of the aggregator is also small. Still, to improve the performance it is possible to change the position of the injectors. With this in mind FIG. 29B shows each of the rows FIG. 29A slightly shifted. The resulting light outputs of the injectors have a smaller interaction with neighboring injectors, thereby reducing the amount of light scattered out of the aggregator. FIG. 29C shows that the technique is flexible and can even be used to focus light to a central region of the solar panel.

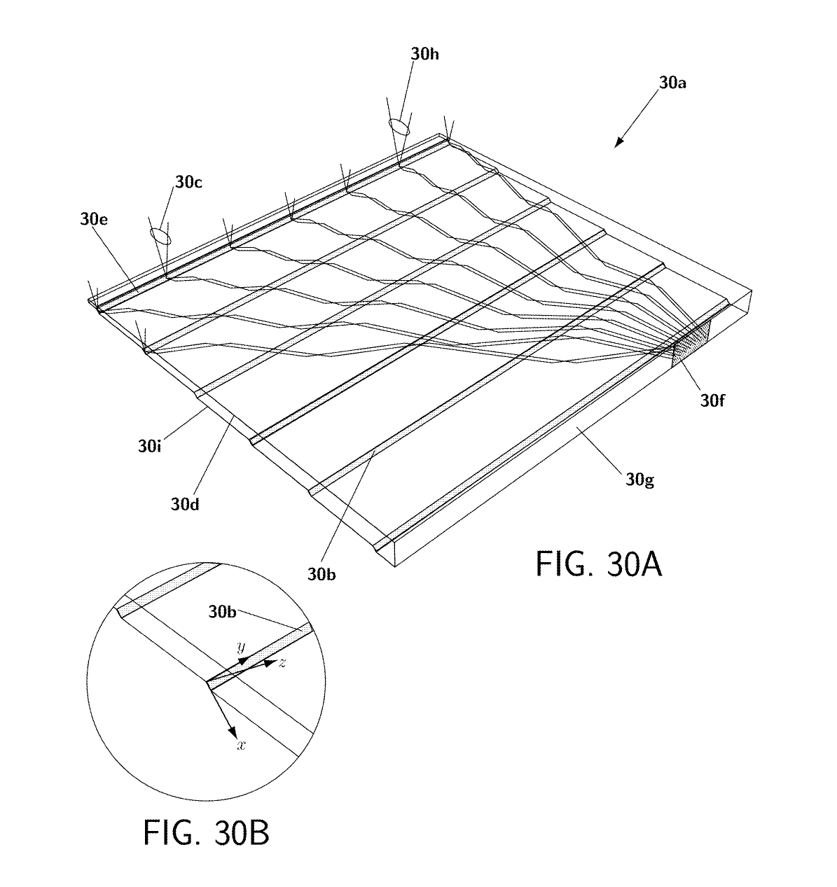

Alternately, in the case of the aggregator shown in FIG. 30A the micro-structured elements of the injectors are based on reflection from aperiodically distributed micro-structured rnirror elements forming an angular band limited uniform diffuser. This not only injects light into the aggregator, but also focuses the light to a receivor, thereby forming a distributed second stage of concentration within the aggregator. Specifically, FIG. 30A shows an embodiment of a three dimensional aggregator 30a with angular band limited uniform diffusers used for its reflective type injectors. An example of a diffuser surface is 30b, which is internal to the aggregator. This embodiment is a variation of FIG. 19B and extends the functionality of the injector to include light insertion and redirection for a second stage of light concentration within the aggregator, sunlight 30c from a deflector (not shown) passes through the aggregator's optical input surface 30d and reflects off of an injector 30e by au angular band limited uniform diffuser. The resulting light energy is trapped within the aggregator and propagates towards the receivor 30f, which would typically be a photovoltaic cell. The receivor may be located on any of the aggregator surfaces and for a common embodiment is located on an edge 30g to minimize the required optical momentum change needed and protects against leakage of light. The reflection of light by the angular-band limited uniform diffuser on injector 30e comprises two components. A first component of the optical momentum is directed into the aggregator in the plane of the cross section shown in FIG. 19B. A second component of the optical momentum within the aggregator is into the page of FIG. 19B. The result is shown in three dimensions in FIG. 30A. Additionally, note that to achieve a focusing of light onto receivor 30f each injector must have a slowly varying probability density of slopes in the y-direction, as specified for an example injector by the Cartesian coordinates shown FIG. 30B. Therefore, by using micro-scale structures that provide a specific probability density of slopes of a micro-structured surface the light may be controlled achromatically in reflection or retraction and this can be used to concentrate and control the flow of light.

While the above description contains many specificities, these should not be construed as limiting the scope of the invention, but instead as merely providing illustrations of some of the embodiments of the invention. The PI is thus not limited to the embodiments or applications described above, but can be changed or modified in various ways on the basis of the general principles of the invention. Such changes or modifications are not excluded from the scope of the invention. Therefore, the scope of the invention should be determined by the appended claims and their legal equivalents, and not exclusively by the examples given.

### INDUSTRIAL APPLICABILITY

The invention has applicability to optical systems that concentrate light, and has special applicability to the solar industry regarding integrated sun tracking for high-concentration solar panels.

### REFERENCE TO DEPOSITED BIOLOGICAL MATERIAL

Not Applicable,

### Sequence Listing Free Text

Not Applicable.

### Patent Literature

U.S. Pat. No. 8,442,790 B2 (QBotix Inc)

U.S. Pat. No, 7,902,490 (DiDomenico)

U.S. Patent application EP2389547A2 (Inspired Solar Technologies)

U.S. Pat. No. 20110226332A1 (Ford et al.)

U.S. Pat. No. 20080271776 (Morgan)

U.S. Pat. No. 6,958,868 (Pender)

U.S. Pat. No. 5,877,874 (Rosenberg)

International Patent Application No. PCT/GB2010/051943 (Tomlinson)

### Non-Patent Literature

“Design and Development of Thin Optical Components for Nonimaging Applications”, a Doctoral Thesis by Dejan Grabovi\ddot{c}kié, Universidad Politécnica De Madrid. 2011,

1. A device for collecting optical radiation, comprising:
(a) at least one receiver;
(b) at least one aggregator, said aggregator comprising a volume;
(c) at least one impedor, said at least one impedor comprising a region of low refractive index compared to the refractive index of said aggregator, wherein said at least one impedor surrounds said at least one aggregator;
(d) a plurality of injectors;
(e) a plurality of deflectors; and
(f) a tracker in combination with tracking control signals, said tracking control signals provided either from the sun or from an external electronic controller, so that said deflectors obtain optical radiation that is correctly oriented for optical processing, whereby optical radiation from a remote moving source of optical radiation is tracked by said tracker and subsequently focused by said plurality of deflectors onto said plurality of injectors, which redirect, as needed, said optical radiation into said volume of said at least one aggregator so that the output of optical radiation from each of said injectors propagates, adds and concentrates within said at least one aggregator towards said at least one receivor.

2. The system of claim 1, wherein said optical radiation is sunlight.

3. The system of claim 1, wherein said tracking control signals are from electronics.

4. The system of claim 1, wherein said one or more receivors are photovoltaic cells.

5. The system of claim 1, wherein said aggregators are stepped in cross section.

6. The system of claim 1, wherein said injectors are wedge shaped in cross section.

7. The system of claim 1, wherein said injectors are based on reflection or refraction.

8. The system of claim 1, wherein said injectors include angular band limited diffusers.

9. The system of claim 1, wherein said deflectors are configured into an array.

10. The system of claim 1, wherein said deflectors reflect and/or refract light.

11. The system of claim 1, wherein said deflectors include oppositely facing mirrors.

12. The system of claim 1, wherein said device for collecting optical radiation includes energy storage and data telemetry.

13. A method for opto-mechanical tracking and redirection of light from a moving light source, comprising:
(a) providing a stator consisting of a predominately transparent medium that is configured to accept internal optical components;
(b) providing a plurality of rotors, located within said stator, consisting of substantially transparent materials having at least one surface for redirecting light, with each of said rotors being able to rotate about its own unique spatially fixed center of rotation, with each of said rotors transmitting light from its own unique real or virtual focal region, with each said unique spatially fixed center of rotation being collocated with its said unique real or virtual focal region;
(c) providing in combination tracking control signals and mechanical actuation of said rotors; and
(d) rotating each of said rotors synchronoirsly with the motion of said light source by operation of said tracking control signals and said mechanical actuation, whereby said stator receives light from said light source and optically compresses the angular extent of said light so that a densely packed arrangement of said rotors may redirect and focus said light to said fixed real or virtual focal regions, which are collocated with said centers of rotation of said rotors, said light is thereby emitted from said fixed real or virtual focal regions independent of the position of said light source.

14. The method of claim 13, wherein said rotor's said real or virtual focal region is formed by at least one optical surface.

15. The method of claim 13, wherein said stator is predominantly a transparent liquid.

16. The method of claim 13, wherein said stator is predominantly a transparent solid.

17. The method of claim 13, wherein said rotors are cylindrical.

18. The method of claim 13, wherein said rotors are spherical.

19. The method of claim 13, wherein said rotors have at least one surface for reflection.

20. The method of claim 13, wherein said rotors have at least one surface for refraction.

21. The method of claim 13, wherein said mechanical actuation of said rotors is through gears or friction.

22. The method of claim 13, wherein said mechanical actuation of said rotors is piezoelectric.

23. A fluidic stator, comprising:
(a) a solid and transparent stator enclosure;
(b) a transparent fluid contained within said stator enclosure;
(c) an optical input surface formed on said stator enclosure;
(d) an optical output surface formed on said stator enclosure; and
(e) a plurality of rotors submerged in said transparent fluid,
whereby, said plurality of rotors me surrounded by said transparent fluid.

24. The system of claim 23, wherein said transparent fluid is selected from the group consisting of predominantly Cargille refractive index matching liquid, propylene glycol or glycerin.

25. An optomechanical rotor, comprising:
(a) a first optical surface that refracts or reflects light energy incident on it from a predetermined direction;
(b) a second optical surface that refracts or reflects light incident on it from said first optical surface;
(c) a real or virtual focus, which is formed by said second optical surface; and
(d) a rotational center of said rotor, whereby light incident on said first optical surface is refracted or reflected to said second optical surface and the resulting redirected light is further refracted or reflected by said second optical surface to said real or virtual focus, which is collocated at said rotational center of said rotor so that light always appears to be emitted substantially from said rotational center of said rotor.

26. The system of claim 25 wherein said rotational center is the geometric center of a portion of sphere or cylinder forming said rotor.

27. The system of claim 25 wherein said first optical surface is a perturbation and portion of hyperbolic having a cross section given by equations 2-5 and said second optical surface is a perturbation and portion of a curve, which in cross section is given by an oval of the form of equations 6-10.

28. An optical aggregator stage, comprising:
(a) a stepped cross sectional profile having at least two goings;
(b) a plurality of area-constrained optical input apertures formed on or about the surface of said optical aggregator;
(c) a light-guiding volume bounded by a plurality of reflecting surfaces formed by said at least two goings; and
(d) at least one optical output surface, whereby light from said area-constrained optical input apertures expands into said stepped cross sectional profile, which has said at least two goings formed thereon to provide at least two optical surfaces for substantially trapping said light from said area-constrained optical input apertures within said light-guiding volume by a plurality of reflections while also accumulating and concentrating said light, said light from, said area-constrained optical input apertures propagating within said light-guiding volume to said at least one optical output surface.

29. The system of claim 28, wherein said optical aggregator takes the form of a parallelogram when viewed from a direction normal to its input surface.

30. The optical aggregator of claim 28, wherein said plurality of area-constrained optical input apertures are formed on risers connecting said goings.

31. The optical aggregator of claim 28. wherein said cross sectional profile has a uniform average thickness.

32. The optical aggregator of claim 28, wherein said reflecting surfaces provide TIR.

33. The optical aggregator of claim 28, wherein said optical aggregator has separate spectral bands.

34. A method for tracking the sun, comprising:
(a) providing a plurality of optical rotors having their geometric centers constrained in a plane and their individual optical axes aligned in the same direction;
(b) providing a transparent friction plate;
(c) providing at least one linear actuator to actuate said friction piate; and
(d) providing at least one independent control signal to control said at least one linear actuator, whereby said plurality of optical rotors are mechanically coupled through said transparent friction plate so that said at least one linear actuator can control the position of said friction plate, and by means of the friction between said friction plate and said plurality of optical rotors, also synchronously control the orientation of said optical rotors so that said control signals urge said plurality of optical rotors to track the sun.
